(19) United States
(12) Patent Application Publication
(10) Pub. No.: US 2018/0101975 A1
(43) Pub. Date: Apr. 12, 2018

(54) ANIMATING A VIRTUAL OBJECT

(71) Applicant: NaturalMotion Limited, Oxford (GB)

(72) Inventor: Danny Chapman, Oxford (GB)

(21) Appl. No.: 15/839,488

(22) Filed: Dec. 12, 2017

Related U.S. Application Data
(63) Continuation of application No. 15/735,379.

(51) Int. Cl. G06T 13/20

(52) U.S. Cl. CPC G06T 13/20

(57) ABSTRACT

A computer-implemented method of configuring animation of a virtual object, wherein the method comprises: generating and storing in a memory, for a group of object parts of the virtual object, an ordered sequence of at least two data sets, wherein each data set comprises one or more respective constraints, wherein each constraint specifies a respective relationship between two one or more object parts in the, group of object parts that are updateable by application of the constraint, wherein the first data set in the ordered sequence of data sets is a specified data set of one or more constraints and wherein said generating comprises, for each data set in the ordered sequence of data sets other than the first data set in the ordered sequence of data sets, generating each constraint in said data set based, at least in part, on one or more respective constraints of one or more data sets that precede said data set in the ordered sequence of data sets; and configuring an animation system to animate the virtual object, wherein animation of the virtual object comprises a processor of the animation system performing a series of update steps, wherein each update step comprises: for each object part in the group of object parts, updating that object part; and performing an iterative process that comprises one or more iteration steps, wherein each iteration step is arranged to apply, as necessary, the data sets in the ordered sequence of data sets, in the order for the ordered sequence of data sets, to the group of object parts.

### TECHNICAL FIELD

The invention relates to the technical field of the animation of a virtual object and the configuration of the animation of a virtual object.

### BACKGROUND

It is known to author or generate animation for one or more virtual objects that are located in a virtual environment (or virtual world), such as a three dimensional virtual environment of a video game or of a visual effects tool. The processing required for such animations can be quite processor-intensive and it would, therefore, be desirable to be able to reduce the amount of processing required while still achieving the same level of quality of animation.

### BRIEF DESCRIPTION OF THE DRAWINGS

Embodiments will now be described, by way of example only, with reference to the accompanying drawings, in which:

FIG. 1 schematically illustrates an example of a computer system;

FIGS. 2a, 2b, 2c, 2d, 2e, 2f and 2g schematically illustrate example virtual objects within a virtual world;

FIG. 3 schematically illustrates some of the data that may be stored in a memory of the computer system of FIG. 1;

FIG. 4 schematically illustrates an example system for animating a virtual object, according an embodiment;

FIG. 5 is a flowchart illustrating a method for animating an object using the system of FIG. 4 according to an embodiment;

FIG. 6 is a flowchart illustrating a method for applying constraints as part of the method of FIG. 5 according to an embodiment;

FIG. 7 schematically illustrates an example of updating the positions of two object parts in order to satisfy a fixed distance constraint;

FIG. 8 is a flowchart illustrating a method of configuring animation of a virtual object according to an embodiment;

FIG. 9 is a flowchart illustrating an iteration method that may be used by the constraints module to implement some embodiments;

FIGS. 10a-d, 12a, 12b, 13 and 16 schematically illustrate examples of generating constraints;

FIG. 11 schematically illustrates a potential undesirable artefact in the animation of an object;

FIG. 14 is a flowchart illustrating an iteration method that may be used by the constraints module to implement some embodiments; and

FIG. 15 is a flowchart illustrating an iteration method that may be used by the constraints module to implement some embodiments.

### DETAILED DESCRIPTION

In the description that follows and in the figures, certain embodiments are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

### 1—System Overview

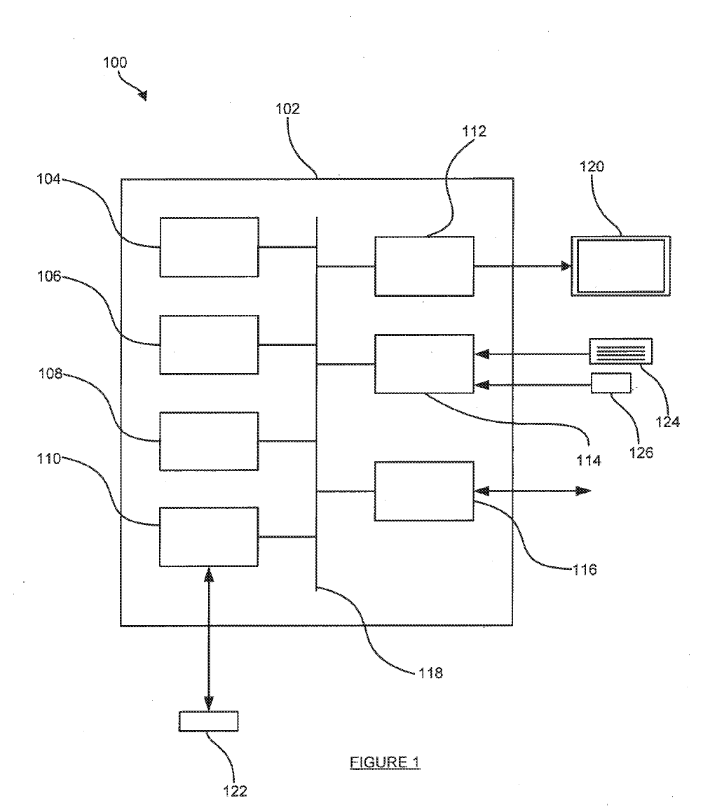

FIG. 1 schematically illustrates an example of a computer system 100. The system 100 comprises a computer 102. The computer 102 comprises: a storage medium 104, a memory 106, a processor 108, an interface 110, a user output interface 112, a user input interface 114 and a network interface 116, which are all linked together over one or more communication buses 118.

The storage medium 104 may be any form of non-volatile data storage device such as one or more of a hard disk drive, a magnetic disc, an optical disc, a ROM, etc. The storage medium 104 may store an operating system for the processor 108 to execute in order for the computer 102 to function. The storage medium 104 may also store one or more computer programs (or software or instructions or code).

The memory 106 may be any random access memory (storage unit or volatile storage medium) suitable for storing data and/or computer programs (or software or instructions or code).

The processor 108 may be any data processing unit suitable for executing one or more computer programs (such as those stored on the storage medium 104 and/or in the memory 106), some of which may be computer programs according to embodiments or computer programs that, when executed by the processor 108, cause the processor 108 to carry out a method according to an embodiment and configure the system 100 to be a system according to an embodiment. The processor 108 may comprise a single data processing unit or multiple data processing units operating in parallel, separately or in cooperation with each other. The processor 108, in carrying out data processing operations for embodiments, may store data to and/or read data from the storage medium 104 and/or the memory 106.

The interface 110 may be any unit for providing an interface to a device 122 external to, or removable from, the computer 102. The device 122 may be a data storage device, for example, one or more of an optical disc, a magnetic disc, a solid-state-storage device, etc. The device 122 may have processing capabilities for example, the device may be a smart card. The interface 110 may therefore access data from, or provide data to, or interface with, the device 122 in accordance with one or more commands that it receives from the processor 108.

The user input interface 114 is arranged to receive input from a user, or operator, of the system 100. The user may provide this input via one or more input devices of the system 100, such as a mouse (or other pointing device) 126 and/or a keyboard 124, that are connected to, or in communication with, the user input interface 114. However, it will be appreciated that the user may provide input to the computer 102 via one or more additional or alternative input devices (such as a touch screen). The computer 102 may store the input received from the input devices via the user input interface 114 in the memory 106 for the processor 108 to subsequently access and process, or may pass it straight to the processor 108, so that the processor 108 can respond to the user input accordingly.

The user output interface 112 is arranged to provide a graphical/visual and/or audio output to a user, or operator, of the system 100. As such, the processor 108 may be arranged to instruct the user output interface 112 to form an image/video signal representing a desired graphical output, and to provide this signal to a monitor (or screen or display unit) 120 of the system 100 that is connected to the user output interface 112. Additionally or alternatively, the processor 108 may be arranged to instruct the user output interface 112 to form an audio signal representing a desired audio output, and to provide this signal to one or more speakers 121 of the system 100 that is connected to the user output interface 112.

Finally, the network interface 116 provides functionality for the computer 102 to download data or computer code from and/or upload data or computer code to one or more data communication networks.

It will be appreciated that the architecture of the system 100 illustrated in FIG. 1 and described above is merely exemplary and that other computer systems 100 with different architectures (for example with fewer components than shown in FIG. 1 or with additional and/or alternative components than shown in FIG. 1) may be used in embodiments. As examples, the computer system 100 could comprise one or more of: a personal computer; a server computer; a mobile telephone; a tablet; a laptop; a television set; a set top box; a games console; other mobile devices or consumer electronics devices; etc.

### 2—Animations and Constraints

Embodiments are concerned with animations and, in particular, an animation of a virtual object that is located (or resides) within a virtual world (or environment).

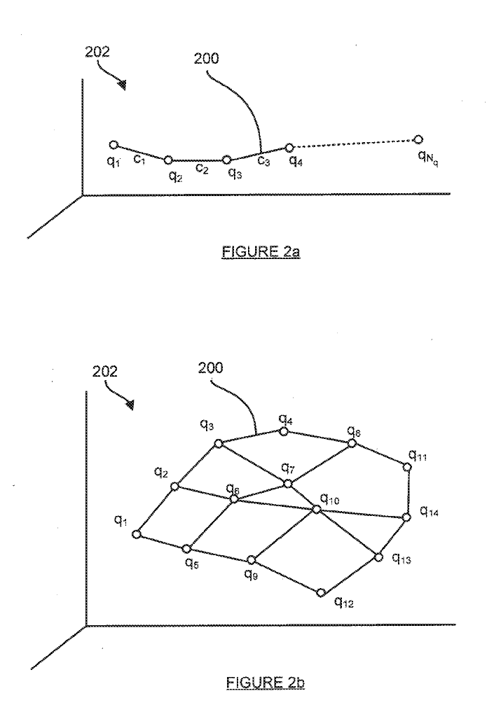

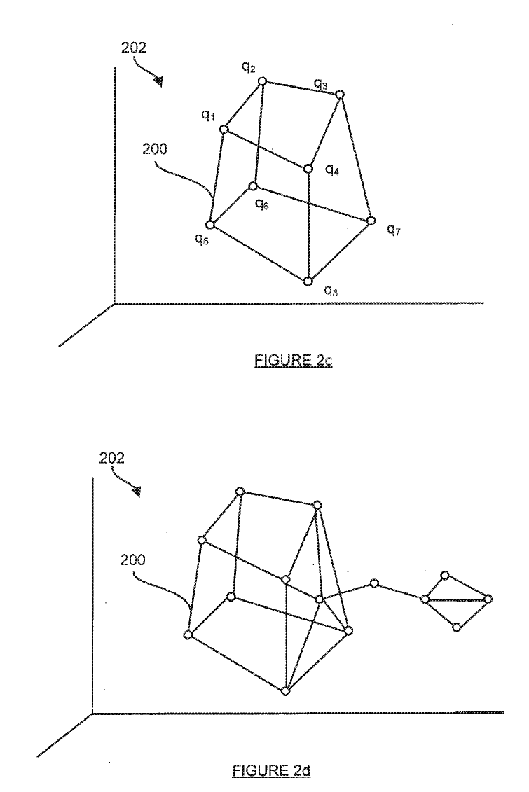

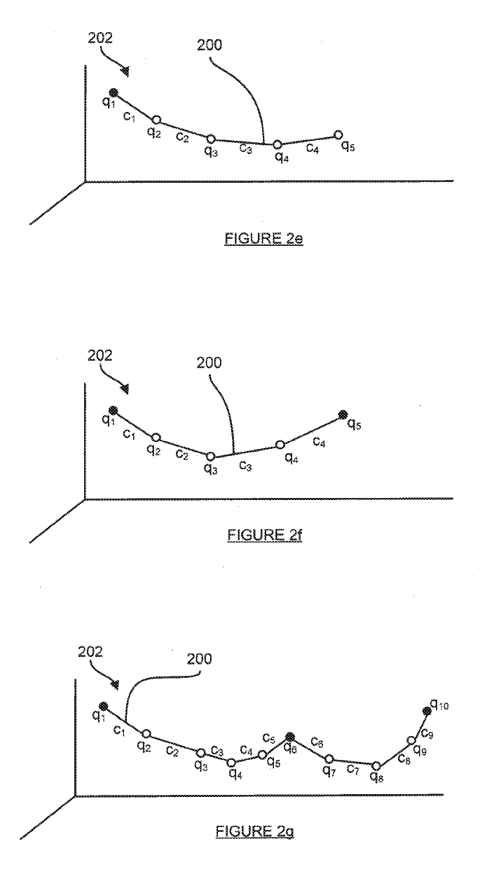

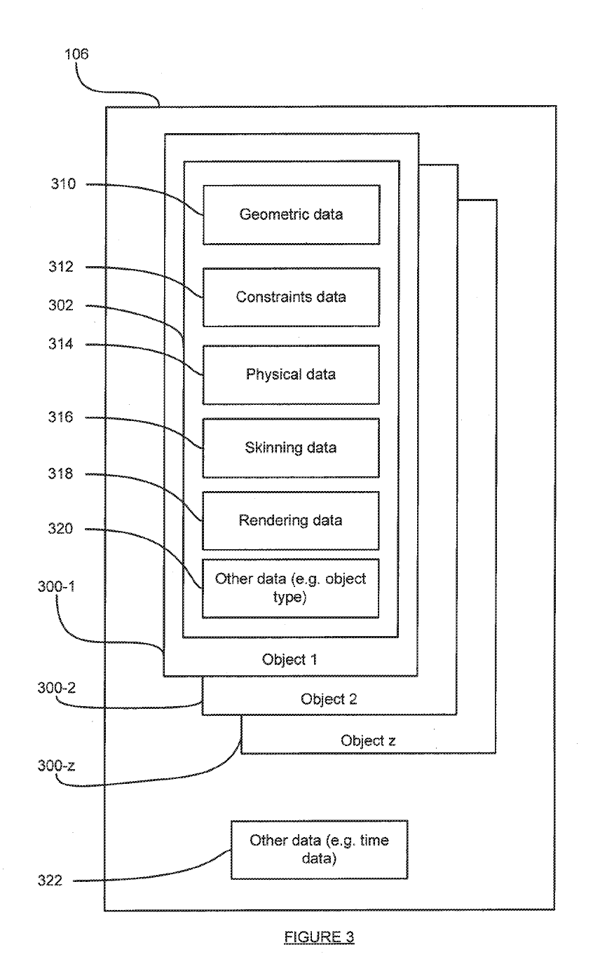

FIGS. 2a, 2b, 2c, 2d, 2e, 2f and 2g schematically illustrate example virtual objects 200 within a virtual world 202.

The virtual world 202 may be any virtual environment, arena or space containing one or more virtual objects 200 and in which these one or more virtual objects 200 may be moved or animated. Thus, the virtual world 202 may represent a real-world location, a fictitious location, a building, the outdoors, underwater, in the sky, a scenario/location in a game or in a movie, etc. The virtual world 202 may be 2-dimensional or 3-dimensional (as shown in FIGS. 2a, 2b, 2c, 2d, 2e, 2f and 2g).

The animation of the virtual object 200 may form a part of a computer game being executed by the processor 108 of the computer system 100, with the animation being generated/computed in real-time. The animation of the virtual object 200 may be generated/computed so as to output a video animation to form part of a film/movie (in which case the generation/computation need not be in real-time). The animation of the virtual object 200 may be generated/computed for other purposes (e.g. computer simulations that involve objects moving and interacting in an environment).

Each object 200 comprises, or is represented (at least in part) by, a group (or a plurality) of object parts the object parts are represented in the figures as small circles. In the following, the number of object parts is represented by N_{q} (where N_{q} is an integer greater than 1), and the object parts themselves are referred to as q₁, . . . , q_{N}_{_{q}}. It will be appreciated that the object 200 may comprise more than N_{q} object parts, but that embodiments and the processing described herein may apply to just a subset of these object parts (namely just N_{q} of the total number of object parts). Each object part may be viewed as a respective node of the object 200, or a location/position in the virtual world 202 of a part of the object 200, Thus, the group of object parts may be viewed as a collection or group of particles that collectively or jointly make up or represent the object 200 (or at least a part of the object 200). Thus, the object parts may be viewed as forming a framework or skeleton for the object 200 (or for at least a part of the object 200).

The group of object parts has an associated predetermined, or pre-specified, set (or data set) of constraints, referred to herein as constraint set S₁. In general, a “constraint” represents, or specifies or imposes, a respective relationship between two or more object parts in the group of object parts. Put another way, a “constraint” represents, or specifies or imposes, a respective relationship between, or a function of, a property of two or more object parts in the group of object parts—the property could be any characteristic or attribute of the object parts, such as position data for those object parts, colour data for those object parts, temperature data for those object parts, data representing a level of “damage” to/at those object parts, etc.

In the following example embodiments, each constraint is a “distance constraint”, namely a constraint that specifies a respective relationship on the relative positions of two respective object parts (thereby constraining or limiting the distance, or the allowable distance, between those two object parts). For example, the position of each object part may be represented by a corresponding position vector relative to some frame of reference (or coordinate system) in the virtual world 202 (which could, for example, be a predetermined frame of reference for the virtual word 202 or could be a frame of reference associated with the object 200). Thus, if two object parts qₓ and q_{y} have corresponding position vectors pₓ and p_{y} in this frame of reference, then a distance constraint will impose some relationship on pₓ and p_{y}. For example, a distance constraint associated with two object parts qₓ and q_{y} may specify one or more of:
A fixed distance should be maintained between those two object parts qₓ and q_{y}, e.g. |pₓ−p_{y}|=d_{x,y} for some value d_{x,y} for those two object parts qₓ and q_{y}.
A maximum a loveable distance between those two object parts qₓ and q_{y} (representing a degree of elasticity between those object parts qₓ and q_{y}) e.g. |pₓ−p_{y}|<d_{x,y} or |pₓ−p_{y}|≤d_{x,y} for some value d_{x,y} for those two object parts qₓ and q_{y}.
A minimum allowable distance between those two object parts qₓ and q_{y}, (representing a degree of compressibility between those object parts qₓ and q_{y}) e.g. |pₓ−p_{y}|>d_{x,y} or |pₓ−p_{y}|≥d_{x,y} for some value d_{x,y} for those two object parts qₓ and q_{y}.
A range or set of allowable distances between those two object parts qₓ and q_{y}, i.e. range or set of values for |pₓ−p_{y}|.
Some other criterion based on |pₓ−p_{y}| or based on pₓ and p_{y}.

The object 200 of FIG. 2a schematically illustrates an object 200 that comprises N_{q} object parts, q₁, . . . , q_{N}_{_{q}}. As mentioned, each object part qₙ (n=1, . . . , N_{q}) has a corresponding position or location within the virtual world 202, which may be represented by a position vector pₙ (relative to some frame of reference). The set S₁ comprises constraints cₙ (n=1, . . . , N_{q-1}), where constraint cₙ is a distance constraint for, or associated with, the pair of object parts qₙ and qₙ₊₁—FIG. 2a, the constraints correspond to the lines that connect circles. This means that the object 200 shown in FIG. 2a is a 1-dimensional object, insofar as it represents a line (e.g. a rope, a chain, a tail, a string, etc.) within the virtual world 202.

The object 200 of FIG. 2b comprises 14 object parts (i.e. N_{q}=14), namely object parts q₁,q₂, . . . ,q₁₄. As mentioned, each object part qₙ (n=1, . . . ,14) has a corresponding position or location within the virtual world 202, which may be represented by a position vector pₙ. The set S₁ comprises constraints c_{x,y}, represented in FIG. 2b as lines joining respective object parts qₓ and q_{y}, where constraint c_{x,y} is a distance constraint for the pair of object parts qₓ and q_{y}. These constraints mean that the object 200 shown in FIG. 2b is a 2-dimensional object (e.g. a cloth, a flag, etc.), insofar as it is a surface represented by polygons within the virtual world 202, It will be appreciated that other surfaces could be represented by different numbers of object parts in different configurations with a different set of constraints S₁.

The object 200 of FIG. 2c comprises 8 object parts (i.e. N_{q}=8), namely object parts q₁,q₂, . . . ,q₈. As mentioned, each object part qₙ (n=1, . . . ,8) has a corresponding position or location within the virtual world 202, which may be represented by a position vector pₙ. The set S₁ comprises constraints c_{x,y}, represented in FIG. 2c as lines joining respective object parts qₓ and q_{y}, where constraint c_{x,y} is a distance constraint for the pair of object parts qₓ and q_{y}. These constraints mean that the object 200 shown in FIG. 2c is a 3-dimensional object (e.g. a ball, a box, etc.) within the virtual world 202. It will be appreciated that other 3-dimensional objects could be represented by different numbers of object parts in different configurations with a different set of constraints S₁.

It will be appreciated that an object 200 may comprise one or more 1-dimensional sections (such as the one shown in FIG. 2a), one or more 2-dimensional sections (such as the one shown in FIG. 2b) and one or more 3-dimensional sections (such as the one shown in FIG. 2c). An example of this is shown in FIG. 2d.

Each object part in the group of object parts is an object part that is updateable by application of a constraint that relates to that object part In other words, where a constraint represents, or specifies or imposes, a respective relationship between two or more object parts (or represents, or specifies or imposes, a respective relationship between, or a function of, a property of two or more object parts in the group of object parts), then each of those two or more object parts (or the property of each of those two or more object parts) is updateable by application (or enforcement) of that constraint. Application of constraints shall be described in more detail later.

The object 200 of FIG. 2e schematically illustrates an object 200 that comprises 5 object parts, namely object parts q₁,q₂, . . . ,q₅. Constraints cₙ (n=1, . . . ,4) are defined, where constraint cₙ is a distance constraint for, or associated with, the pair of object parts qₙ and qₙ₊₁. In FIG. 2e, the object part q₁ is shown filled-in. This is to indicate that this object part is not updateable by virtue of application of any of the constraints c₁, . . . ,c₄. For example, the object part q₁ may be fixed or anchored in the virtual world 202 (so that its position, or other property, is not adjusted when applying the constraints)—the object 200 could represent, for example, a rope attached to a wall by one end. Thus, whilst the object 200 comprises 5 object parts, the group of object parts under consideration actually comprises the 4 updateable object parts q₂, . . . ,q₅, so that N_{q}=4 and so that the set S₁ comprises the constraints c₂, c₃, c₄ (i.e. not the constraint c₁ that involves the non-updateable object part q₁).

The object 200 of FIG. 2f schematically illustrates an object 200 that comprises 5 object parts, namely object parts q₁,q₂, . . . ,q₅. Constraints cₙ (n=1, . . . ,4) are defined, where constraint cₙ is a distance constraint for, or associated with, the pair of object parts qₙ and qₙ₊₁. In FIG. 2f, the object parts q₁ and q₅ are shown filled-in. This is to indicate that these object parts are not updateable by virtue of application of any of the constraints c₁, . . . ,c₄. For example, the object parts q₁ and q₅ may be fixed or anchored in the virtual world 202 (so that their respective positions, or other properties, are not adjusted when applying the constraints)—the object 200 could represent, for example, a rope attached to walls by both ends. Thus, whilst the object 200 comprises 5 object parts, the group of object parts under consideration actually comprises the 3 updateable object parts q₂,q₃,q₄ so that N_{q}=3 and so that the set S₁ comprises the constraints c₂, c₃ (i.e. not the constraints c₁ and c₄ that involve the non-updateable object part q₁ or q₅).

The object 200 of FIG. 2g schematically illustrates an object 200 that comprises 10 object parts, namely object parts q₁,q₂, . . . ,q₁₀. Constraints cₙ (n=1, . . . ,9) are defined, where constraint cₙ is a distance constraint for, or associated with, the pair of object parts and qₙ₊₁. In FIG. 2g, the object parts q₁, q₆ and q₁₀ are shown filled-in. This is to indicate that these object parts are not updateable by virtue of application of any of the constraints c₁, . . . ,c₉. For example, the object parts q₁, q₆ and q₁₀ may be fixed or anchored in the virtual world 202 (so that their respective positions, or other properties, are not adjusted when applying the constraints)—the object 200 could represent, for example, a rope attached to walls by both ends and somewhere between the ends. Thus, whilst the object 200 comprises 10 object parts, the group of object parts under consideration actually comprises the 7 updateable object parts q₂, . . . ,q₅ and q₇, . . . ,q₉ so that N_{q}=7 and so that the set S₁ comprises the constraints c₂, c₃, c₄, c₇, c₈ (i.e. not the constraints c₁, c₅, c₆ and c₉ that involve the non-updateable object part q₁ or q₆ or q₁₀).

It will be appreciated that an object part may be set to be (or identified as being) non-updateable in a number of ways. For example, an object part may be set so that its position is not updateable by settings its associated mass attribute to be arbitrarily high (potentially infinite), so that simulated application of a force to that object part will not move that object part (or move it only a negligible amount), Alternatively, an object part may have an associated property or flag that indicates that that object part is not updateable. It should be noted that, in the above discussion, an object part is referred to as “non-updateable” if the application of the constraints is not allowed to update that object part—it is, however, still possible that, during the animation as a whole, that object part could be updated via some other mechanism as part of the animation, e.g.: due to collision between the object 200 and another object in the virtual world 202; due to a global movement of the object 200 within the virtual 202 (in contrast to movement of the object parts of the object 200 via the constraints to adjust the internal configuration of the object 200); etc.

It will be appreciated that a constraint need not specify a relationship between just two object parts, nor need a constraint be based on a property of just two object parts. For example, for a set of M object parts (e.g. object parts q₁,q₂, . . . ,q_{M}), that have respective position vectors p₁, p₂, . . . ,p_{M}, let g=Σᵢ₌₁^{M-1}|pᵢ−pᵢ₊₁|, then (a) a constraint may be specified for these M object parts that specifies a relationship such as g=d or g<d or g≤d or g>d or g≥d for some value d; and/or (b) a constraint may be specified for the pair of object parts q₁ and q_{M} that specifies a relationship such as |p₁−p_{M}|=αg or |p₁−p_{M}|<αg or |p₁−p_{M}|≤αg or |p₁−p_{M}|>αg or |p₁−p_{M}|≥αg for some positive value α. It will be appreciated that other examples of this exist. In the following, for the sake of clarity and ease of explanation, embodiments shall generally be described in which constraints specify a relationship between two object parts. However, it will be appreciated that in other embodiments, constraints may specify relationships between respective larger numbers of object parts (which may be different from one constraint to another constraint).

The object parts and their associated position vectors (or their associated locations within the virtual world 202), therefore help define the overall shape or configuration for the virtual object 200. The distance constraints between object parts help to define or constrain how the virtual object 200 may be moved or animated (e.g. a degree of flexibility or elasticity or compressibility, or rigidity/stiffness, etc.)—for example, how a piece of cloth may be stretched or may flap or may fold.

An animation for an object 200 comprises performing an update process (also referred to as an animation update step) at each time point in a series of time points, i.e. performing a series of animation update steps at corresponding update time points. These time points may correspond to video frames, video fields, or any other time or display frequency of interest—for the rest of this description, the time points shall be assumed to correspond to video frames, but it will be appreciated that this is only an example and should not be taken as limiting. The time between successive time points may be constant or may vary. For example, in some embodiments, one or more animation update steps may be carried out between successive video frames/fields and this number may or may not be constant over time. It will be appreciated that the display frequency (i.e. the frequency at which a display process displays or renders an image of the virtual world 202) need not necessarily be linked to the frequency of performing the update process. The update process performed at the update time point updates values for attributes of (or associated with) the object 200. These attributes may correspond to, for example, the location of one or more of the object parts of the object 200. Thus, in updating the values for the location attributes, the object 200 may be moved as a whole and/or have its shape changed within, the virtual world 202. However, the attributes associated with the object 200 are not limited to location of object parts, as discussed later.

FIG. 3 schematically illustrates some of the data that may therefore be stored in the memory 106 (or additionally or alternatively stored in the storage medium 104 or the data storage device 122, or which may be accessible via the network interface 116). There may be respective data 300 for one or more objects 200—in FIG. 3, there are z objects 200, each with their own data 300-1, 300-2, . . . , 300-z (where z is a positive integer). The data 300 for an object 200 may include a set 302 of attribute data for that object 200, including one or more of:
Geometric data 310—The geometric data 310 for the object 200 represents the positions of the object parts of the object 200. The geometric data 310 may simply store a position vector for each of the object parts relative to some frame of reference (or coordinate system) in the virtual world 202 (which could, for example, be a predetermined frame of reference for the virtual world 202 or could be a frame of reference associated with the object 200). Additionally or alternatively, one or more of the object parts may have its position within the virtual world 202 represented by storing, in the geometric data 310, a vector for that object part relative to another object part. It will be appreciated that other ways of representing positions of object parts may be used.
Constraints data 312—The constraints data 312 specifies, or represents, the one or more constraints, such as the set of constraints S₁ mentioned above.
Physical data 314—The physical data represents various physical attributes (or “properties”) for the object 200. These physical attributes represent or impose various physical properties or restrictions or limitations on the object 200. For example, one or more object parts, or one or more groups of object parts, may have corresponding physical data representing attributes such as:
   Size and shape of a region around that object part. The region may be a capsule or a cylinder, with the size and shape being defined by lengths and radii accordingly. The region(s) may represent the body, or the “bulk”, of the object 200 that is supported by the framework of object parts. If another object 200 were to enter, penetrate or perhaps even just contact the region(s), then the two objects 200 may be considered to have collided.
   A mass for the object part.
   An inertia property for the object part.
   However, some of the object parts may not have corresponding physical attributes.
Skinning data 316—The skinning data 316 is data that enables so-called “skinning” for the animation. The process of skinning is well-known in this field of technology and shall not be described in more detail herein - it takes a definition of a surface of the object 200 and attaches it to the skeleton/framework formed by the object parts. The skinning data is therefore data defining a surface of the object that will be presented when rendering the animation.
Rendering data 318—The rendering data 318 is data that enables so-called “rendering” of the animation, The process of rendering is well-known in this field of technology and shall not be described in more detail herein—it actually outputs or displays the skinned surface with relevant textures, colours, lighting, etc. as appropriate. The rendering data 318 is therefore data defining the textures, colours, lighting, etc., which are attributes of the object 200.
Other data 320 specific to that object (e.g. a type of the object 200).

There may also be stored other data 322 (such as data defining a time within a computer game or a movie; data defining or describing the virtual world 202; etc.) which is not specific to any one particular object 200.

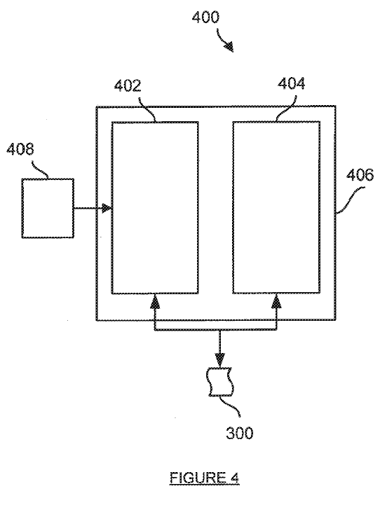

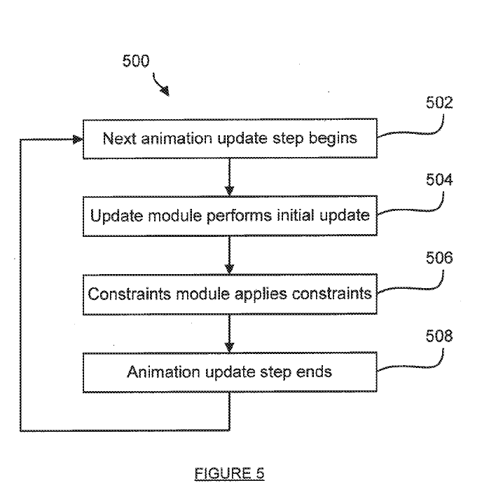

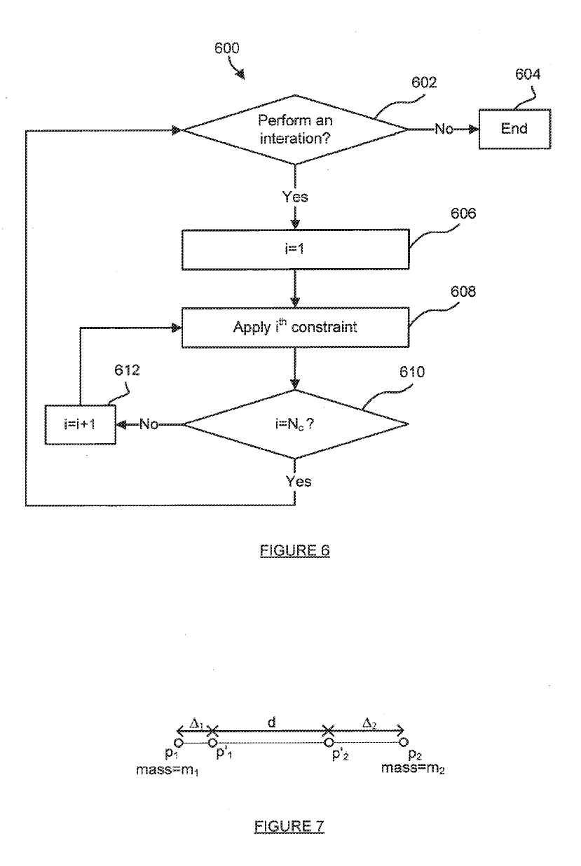

FIG. 4 schematically illustrates an example system 400 for animating a virtual object 200, according an embodiment. The system 400 may, for example, be implemented as one or more computer programs (or one or more software modules) and may, therefore, be executed by the processor 108 of the system 100 of FIG. 1.

The virtual world 202 may comprise a plurality of objects 200, and each object 200 may have its own corresponding system 400 implemented in order to animate that object 200. Alternatively, a system 400 may be used to animate a plurality of objects 200 (e.g. by sequentially or successively updating the configuration/data 300 for a plurality of objects 200 at an animation update step, or performing such updates in parallel for the plurality of objects 200). The description below therefore sets out how the system 400 may be used to animate a specific object 200 (with the same operations potentially being performed for other objects 200 in the virtual world 202).

The system 400 comprises an update module 402 and a constraints module 404. The update module 402 and the constraints module 404 may form part of (or may be viewed as forming part of) an animation system/engine 406 (which may carry out other animation functionality in addition to that performed by the update module 402 and the constraints module 404).

In summary, the update module 402 is arranged to perform an initial (or intermediate or first) update of the geometric data 310 for the object 200 for the current animation update step. For this, the update module 402 may receive a set of one or more input parameters 408 (or data or information) and use this set of input parameters 408 to perform the initial update of the geometric data 310 for the object 200. The constraints module 404 is arranged to apply the constraints, as specified by the constraints data 312, to the group of object parts for the object 200 the aim is to try to ensure that the group of object parts complies with the one or more constraints represented by the constraints data 312. Thus, the constraints module 404 may update some or all of the geometric data 310 for the object 200 (after it has been initially updated at this animation update step by the update module 402), although such a further update may not always be necessary if the group of object parts already complies with the constraints after the initial update by the update module 402.

Each parameter in the set of one or more input parameters 408 may be an amount of data or a value representing a quantity intended to influence or control the animation of the object 200 for a next animation update step of the animation. The set of input parameters 408 may, therefore, include one or more parameters that are one or more of:
Inputs from a user (or some other controller of a game or animation tool). For example, the user inputs may identify a desired movement of the object 200, potentially including one or more properties of the movement such as a direction in which the object 200 is to move, a style in which the object 200 is to move, etc. (e.g. “move at 70% of maximum speed”, etc.).
Data indicating how the object 200 has interacted with the virtual environment 202. This data could include, for example, an indication that a part of the object 200 has collided, or made contact, with a part of its virtual world 202 (e.g. another object within the virtual world 202), or that the object 200 is approaching another object within the virtual world 202 (with the intention then being that the object 200 should then be animated to take an evasive or protective manoeuvre).
Other data or information about the state of the object 200 and/or the virtual world 202.

FIG. 5 is a flowchart illustrating a method 500 for animating an object 200 using the system 400 of FIG. 4 according to an embodiment.

At a step 502, a next animation update step (in the sequence/series of animation update steps) begins. This “next” animation update step then becomes the “current” animation update step.

At a step 504, the update module 402 performs its initial update—i.e. each of the object parts in the group of object parts is updated. When, for example, the constraints are distance constraints (or when the property of the object parts to which the constraints apply is the location of the object parts), then the update module 402 performs its initial update by updating the geometric data 310 for the object 200. This shall be described in more detail shortly. Similarly, when the constraints are other types of constraints (or when the property of the object parts to which the constraints apply is an attribute other than the location of the object parts), then the update module 402 performs its initial update by updating corresponding data in the data 300 for the object 200 (instead of the geometric data 310).

At a step 506, the constraints module 404 applies the constraints, as specified by the constraints data 312, to the group of object parts for the object 200. The step 506 aims to try to ensure that the group of object parts complies with the one or more constraints represented by the constraints data 312, although this may not always be achieved. In particular, the initial update at the step 504 may have caused the group of object parts to be no longer compliant with one or more of the constraints represented by the constraints data 312, in which case the step 506 aims to remedy this by further updating the geometric data 310 so as to try to ensure that the constraints are met. Thus, the step 506 may involve updating some or all of the geometric data 310 for the object 200 (after it has been initially updated at this animation update step by the update module 402 at the step 504), although such a further update may not always be necessary if the group of object parts already complies with the constraints after the initial update by the update module 402. As with the step 504, when the constraints are other types of constraints (or when the property of the object parts to which the constraints apply is an attribute other than the location of the object parts), then the constraints module 404 may update corresponding data in the data 300 for the object 200 (instead of the geometric data 310).

At a step 508, the current animation update step ends. This may involve, for example, rendering an image representing the updated configuration of the object 200 (e.g. to depict the animation of the object 200 on the screen 120) and/or saving (or storing) data indicative of the update to the geometric data 310 for the object 200 (so that an animation of the object 200 can be rendered at a later point in time based on this stored data). Other processing may be performed (e.g. to update other data 322 for a game involving the object 200, the update being based on the updated configuration for the object 200, such as scoring game points or losing game lives or proceeding to a next stage in the game, etc.).

Processing may then return to the step 502 in order to perform a further animation update step in the sequence of animation update steps.

In some embodiments, the update module 402 performs the step 504 using so-called “Verlet integration”, Verlet integration is well-known and shall, therefore, only be described below insofar as is necessary for understanding embodiments. In particular, for an object part q in the group of object parts of the object 200, let the current position of that object part q (at the start of the current animation update step) be represented by a position vector p and let the position of that object part q at the start of the previous (or immediately preceding) animation update step have a position vector p_{old} (where p and p_{old} may, for example, be stored as part of the geometric data 310 for the object 200). Then, at the step 504 for the current animation update step, a new position of that object part q, represented by a position vector p_{new}, may be calculated or determined according to:

p_{new}=2p−p_{old}+a·dt²

where dt represents an amount of time between the current animation update step and the previous animation update step and a is an acceleration for the object part q.

The update module 402 may determine the acceleration a is a number of ways (as are well-known in this field of technology)—for example, the update module 420 may be arranged to determine a virtual force F that should be applied to (or be simulated as acting upon) the object part q (such as due to one or more of: the object 200 impacting with another object 200 in the virtual world 200, which may be specified by the parameters 408; a command from a user, which may be specified by the parameters 408; other influences from the virtual world 202, which may be specified by the parameters 408; a gravitational force simulated for the virtual world 202; etc.), in which case the acceleration a may be calculated by the update module 402 according to a=F/m, where m is a mass value for the object part q (which may, as mentioned above, be stored as part of the physical data 314 for the object 200). The update module 402 may, therefore, make use of a physics module or physics simulator to determine a suitable force F and/or the acceleration a. The update module 402 may obtain the acceleration directly (e.g. a predetermined acceleration due to gravity in the virtual world 202; a known acceleration of the object 200 under certain conditions—e.g. an acceleration of a car object 200).

Once p_{new} has been calculated, then the value of p may be copied into p_{old} and the value for p_{new} may be copied into p (i.e. the geometric data 310 for the object 200 may be updated in this manner). The step 506 performed by the constraints module 404 will then be based on p_{new}.

The step 504 may involve performing the above calculations separately for each object part of the object 200 in order to calculate new positions for the object parts. This may, then, result in one or more of the constraints being broken, which is why the method 500 involves carrying out the step 506 after the step 504.

It will be appreciated, however, that the method 500 may involve the update module 402 using any other technique (i.e. techniques other than Verlet integration) to perform an initial update of the positions of the object parts at the step 504. Similarly, when the constraints are other types of constraints (or when the property of the object parts to which the constraints apply is an attribute other than the location of the object parts), then the update module 402 may perform its update using Verlet integration or any other update process suitable for that property type of the object parts.

FIG. 6 is a flowchart illustrating a method 600 for applying constraints at the step 506 of the method 500 of FIG. 5 according to an embodiment.

The method 600 is an iterative process that involves performing one or more iterations (or iteration steps) as necessary. An iteration step may involve one or more of steps 602, 604, 606, 608, 610 and 612 shown in FIG. 6.

At the step 602, the constraints module 404 determines whether or not to terminate the iterative process (which may be terminating at a first iteration or at a subsequent iteration for this animation update step). This may involve performing one or more tests, such as:
The constraints module 404 may be arranged to perform at most a predetermined maximum number of iterations for the step 506. Thus, the constraints module 404 may be arranged to store a counter C that indicates the number of iterations performed so far during the step 506 for the current animation update step. The constraints module 404 may initialise this counter C to be 0 at the start of the method 600 and may increment the counter C by 1 after each iteration is performed. Then, one of the tests at the step 602 may involve determining whether C is greater than a predetermined threshold—if so, then the constraints module 404 determines that the iterative process is to be terminated for the step 506 of the current animation update step; otherwise, the iterative process may continue (subject to the outcome of any further tests that may be performed for the step 602). This test therefore ensures that there is an upper bound on the time taken to carry out the method 600 (and therefore the method 500).
The constraints module 404 may be arranged to test whether a sufficient number, or a sufficient proportion, (possibly all) of the constraints represented by the constraints data 312 are satisfied by the group of object parts. For example:
   A “maximum allowable distance” constraint for two object parts qₓ and q_{y}, that have respective position vectors pₓ and p_{y}, that specifies that |pₓ−p_{y}|<d_{x,y} for some value d_{x,y} for those two object parts qₓ and q_{y}, may be considered to be satisfied if |pₓ−p_{y}|<d_{x,y}.
   A “fixed distance” constraint for two object parts qₓ and q_{y}, that have respective position vectors pₓ and p_{y}, that specifies that |pₓ−p_{y}|=d_{x,y} for some value d_{x,y} for those two object parts qₓ and q_{y}, may be considered to be satisfied if |pₓ−p_{y}|=d_{x,y}. Alternatively, this constraint may be considered to be satisfied if d_{x,y}−δ₁<|pₓ−p_{y}|<d_{x,y}+δ₂ for some positive values δ₁ and δ₂—i.e. the distance between the two object parts qₓ and q_{y} is “close enough” to the desired distance d_{x,y}.
   It will be appreciated that other constraints may be considered to be satisfied according to other corresponding criteria.
Thus, this test at the step 602 may involve determining whether at least one (or possibly whether at least a predetermined number T, where T is a positive integer) of the constraints represented by the constraints data 312 is not satisfied by the group of object parts if so, the iterative process may continue (subject to the outcome of any further tests that may be performed for the step 602); otherwise, the constraints module 404 determines that the iterative process is to be terminated for the step 506 of the current animation update step.
It will be appreciated that other tests/criteria could be used at the step 602 to decide whether or not the iterative process is to continue or to terminate.

If the constraints module 404 determines, based on any of the tests at the step 602, that no more iterations are to be performed (i.e. the iterative process is to be terminated) for the current animation update step, then the method 600 terminates at a step 604. Otherwise, processing continues at the step 606.

The constraints represented by the constraints data 312 may form an ordered set or an ordered list (i.e. they may be arranged as a sequence or series of constraints). Let there be N_{c} constraints (where N_{c} is a positive integer) and let the i^{th} constraint (i=1, . . . ,N_{c}) be represented by cᵢ. Then an iteration may be carried out as follows.

At the step 606, an index value i is initialised to be 1.

At the step 608, the constraints module 404 applies the i^{th} constraint to the group of object parts. This shall be described in more detail shortly.

At the step 610, the constraints module 404 determines whether there are any more constraints to apply to the group of object parts, e.g. by testing whether i=N_{c}. If there is at least one more constraint to apply to the group of object parts (i.e. if i<N_{c}), then processing continues at the step 612 at which i is incremented by 1, following which processing returns to the step 608; otherwise, if there are no more constraints to apply to the group of object parts (i.e. if i=N_{c}), then processing returns to the step 602.

Thus, the steps 606, 608, 610 and 612 effectively apply the constraints, as (or if) necessary (as determined at the step 602), sequentially (i.e. according to the order of the ordered set/list of constraints). It will, however, be appreciated that this could be achieved in different ways, without performing the particular steps 606, 608, 610 and 612.

The application of a constraint c, at the step 608 may be performed in a number of ways. In general, though, as mentioned above, the constraint cᵢ represents, or specifies or imposes, a respective relationship between two or more object parts in the group of object parts or, put another way, the constraint cᵢ represents, or specifies or imposes, a respective relationship between, or a function of, a property of two or more object parts in the group of object parts. Let those object parts be a q_{i,1}, q_{i,2}, . . . , q_{i,Ni} (for some integer Nᵢ greater than 1). Then, application of the constraint cᵢ at the step 608 involves updating (if necessary) one or more of those object parts q_{i,1}, q_{i,2}, . . . , q_{i,Ni} (or updating the relevant property of one or more of those object parts q_{i,1}, q_{i,2}, . . . , q_{i,Ni} so that the constraint cᵢ is then satisfied (according to the one or more satisfaction criteria for that constraint as discussed above). For example:
A “maximum allowable distance” constraint cᵢ for two object parts q_{i,1} and q_{i,2}, that have respective position vectors p_{i,1} and p_{i,2}, that specifies that |p_{i,1}−p_{i,2}|<dᵢ for some value dᵢ for those two object parts q_{i,1} and q_{i,2}, may be considered to be satisfied if |p_{i,1}−p_{i,2}|<dᵢ. Applying the constraint cᵢ at the step 608 may, therefore, involve testing whether this constraint cᵢ is satisfied and, if the constraint cᵢ is not satisfied, then the constraints module 404 may update one or both of p_{i,1} and p_{i,2} so that |p_{i,1}−p_{i,2}|<dᵢ.
A “fixed distance” constraint cᵢ for two object parts q_{i,1} and that have respective position vectors p_{i,1} and p_{i,2}, that specifies that |p_{i,1}−p_{i,2}|=dᵢ for some predetermined value dᵢ for those two object parts q_{i,1} and q_{i,2}, may be considered to be satisfied if |p_{i,1}−p_{i,2}|=dᵢ or, alternatively, if dᵢ−δ₁<|p_{i,1}−p_{i,2}|<dᵢ+δ₂ for some positive values δ₁ and δ₂. Applying the constraint at the step 608 may, therefore, involve testing whether this constraint cᵢ is satisfied and, if the constraint cᵢ is not satisfied, then the constraints module 404 may update one or both of p_{i,1} and p_{i,2} so that |p_{i,1}−p_{i,2}|=dᵢ or so that dᵢ−δ₁<|p_{i,1}−p_{i,2}|<dᵢ+δ₂ as appropriate.

It will be appreciated that, when applying a constraint updating one or more of those object parts q_{i,1}, q_{i,2}, . . . , q_{i,Ni} (or the relevant property of one or more of those object parts q_{i,1}, q_{i,2}, . . . , q_{i,Ni}) so that the constraint cᵢ is then satisfied can be achieved in a number of ways. For example, when the constraint cᵢ is a distance constraint, so that the property of the object parts q_{i,1}, q_{i,2}, . . . , q_{i,Ni} under consideration is the position for those object parts q_{i,1}, q_{i,2}, . . . , q_{i,Ni}, then the positions could be updated in numerous different ways so as to satisfy the constraint cᵢ. Embodiments may, however, use preferred techniques for performing this update. For example, when updating the positions of object parts q_{i,1}, q_{i,2}, . . . , q_{i,Ni}, the distance that each object part q_{i,1}, q_{i,2}, . . . , q_{i,Ni} is moved may be inversely proportional to a mass value (as represented by the physical data 314) for those object parts q_{i,1}, q_{i,2}, . . . , q_{i,Ni} or, put another way, the object parts q_{i,1}, q_{i,2}, . . . , q_{i,Ni} may be moved so that the centre of mass for the object parts q_{i,1}, q_{i,2}, . . . , q_{i,Ni} does not move (which prevents manifestation of an effective acceleration of the object 200).

FIG. 7 schematically illustrates an example of updating the positions of two object parts q₁ and q₂ in order to satisfy a fixed distance constraint that stipulates that the distance between those two object parts q₁ and q₂ should be equal to a distance d. Let the position vectors of the object parts q₁ and q₂ before applying the constraint be p₁ and p₂ respectively, let the position vectors of the object parts q₁ and q₂ after applying the constraint be p′₁ and p′₂ respectively, and let the (simulated) masses of the object parts q₁ and q₂ be m₁ and m₂ respectively. Suppose that, before the constraint is applied, |p₁−p₂|>d. Therefore, the two object parts q₁ and q₂ need to be moved closer together in order to satisfy the constraint. Let the distance that the object part q₁ is moved towards the object part q₂ be Δ₁ so that |p₁−p′₁|=Δ₁ and let the distance that the object part q₂ is moved towards the object part q₁ be Δ₂, so that |p₂−p′₁|=Δ₂. Thus, Δ₁+Δ₂=|p₁−p₂|−d. Additionally, with this preferred method of moving the object parts q₁ and q₂, the following relationship is used: Δ₁m₁=Δ₂m₂. Thus,

$${Δ}_{1} = \frac{{m}_{2} ( \vert {p}_{1} - {p}_{2} \vert - d )}{{m}_{1} + {m}_{2}} and {Δ}_{2} = \frac{{m}_{1} ( \vert {p}_{1} - {p}_{2} \vert - d )}{{m}_{1} + {m}_{2}} .$$

This ensures that the centre of mass of the two object parts q₁ and q₂ remains the same after updating their positions.

However, for some constraints, one or more of the object parts for which the constraint specifies a relationship may, when performing the step 608, remain unchanged. For example, an object part may be fixed at a specific location within the virtual world, e.g. at a position that is predetermined or that is stipulated by the update module 402 (or may have some other attribute that needs to remain constant or as stipulated by the update module 402), and so application of a constraint that relates to that object part may require that object part to not be changed—thus, other object parts will need updating in order to apply the constraint. Thus, in some embodiments, the constraints data 312 may store, in association with one or more constraints, a corresponding indication of which object parts may be updated and/or which object parts may not be updated when applying that constraint.

Applying a constraint at the step 608 may result in a constraint that had previously been satisfied no longer being satisfied. For example, a constraint c₁ may specify that the distance between two object parts q₁ and q₂ needs to be a predetermined value d₁, whilst a constraint c₂ may specify that the distance between the object part q₂ and another object part q₃ needs to be a predetermined value d₂. Application of the constraint c₁ may involve moving the object parts q₁ and q₂ so that the distance between them is d₁. If, prior to this movement, the constraint c₂ was satisfied, then it may no longer be satisfied (due to a new position of the object part q₂). Similarly, subsequent application of the constraint c₂ may involve moving the object parts q₂ and q₃ so that the distance between them is d₂. This movement of the object part q₂ may then cause the constraint c₁ to no longer be satisfied. This is why a number of iterations may be performed. This iterative approach is equivalent to the so-called Gauss-Seidel iteration and should converge to a solution that tries to satisfy the constraints as much as is possible.

A potential problem encountered with such iterative processing, however, is that the number of iterations required to ensure that all of the constraints are met (at least as closely as possible) can sometimes be quite large. For example, with the rope of FIG. 2a, the number of iterations required to keep the length of the rope no more than some percentage (e.g. 10%) of its rest length (i.e. the length of the rope in its default configuration—which could, for example, be specified by maximum allowable distance constraints between the object parts) increases exponentially as the number of object parts increases. Embodiments aim to address this—i.e. to be able to satisfy the constraints in a computationally efficient manner (or, given a particular period of time, aim to satisfy the constraints better in that period of time than would otherwise have been possible without using one of the embodiments or, given a particular period of time, be able to use more object parts for the object 200 than would otherwise have been possible without using one of the embodiments).

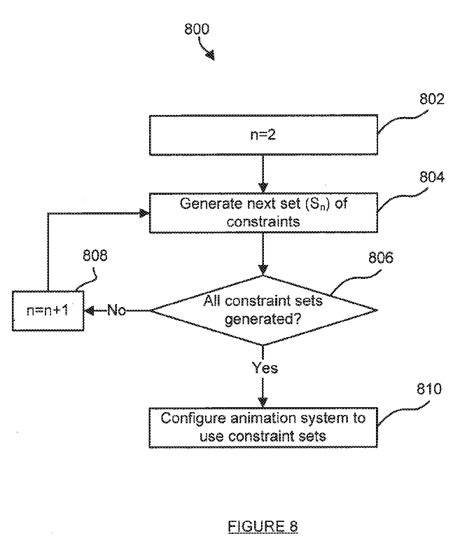

FIG. 8 is a flowchart illustrating a method 800 of configuring animation of a virtual object according to an embodiment. The method 800 may be performed by a computer system 100. This computer system 100 could be a computer system of a designer of the animation of the object 200 (so that, for example, the method 800 may be performed by, or may be implemented by or as part of, an animation design tool)—thus, the computer system that carries out the method 800 may be different from the computer system that actually performs the animation. Alternatively, this computer system 100 could be a computer system of an end user, e.g. a games console (so that, for example, the method 800 may be performed by, or may be implemented by or as part of, a computer game executed by the computer system)—thus, the computer system that carries out the method 800 may be the same computer system that actually performs the animation.

As mentioned above, the group of object parts of the object 200 has an associated predetermined, or pre-specified, set of constraints, referred to herein as constraint set S₁. This initial set of constraints S₁ may, for example, have been specified by an author/designer of the animation (or of the object 200) in order to specify a default (at rest) configuration for the object 200. As shall be described below, one or more further sets (or data sets) of constraints shall be generated. Thus, if there are N_{S} further sets of constraints generated, then the total number of sets of constraints is N_{S}+1. The number N_{S} may be a predetermined number, or could be set by a user (e.g. a designer of the animation of the object 200). Let these N_{S} further sets of constraints be referred to herein as constraint sets S₂, S₃, . . . , S_{N}_{_{S}}₊₁. The constraint sets S₁, S₂, S₃, . . . , S_{N}_{_{S}}₊₁ may, therefore, be viewed as an ordered list/sequence of constraint sets Sᵢ (i=1, . . . , N_{S}+1). Additionally, for each constraint set Sₙ (n=1, . . . , N_{S}+1), let the number of constraints in that constraint set Sₙ be Kₙ (where Kₙ is a positive integer) and let those Kₙ constraints be represented as c_{n,1}, c_{n,2}, . . . , c_{n,K}_{ₙ}

The method 800 begins at a step 802, at which an index value n is initialised to be 2.

At a step 804, a next constraint set Sₙ is generated. This shall be described in more detail later, however, in general, the generation of each constraint c_{n,1}, c_{n,2}, . . . , c_{n,K}_{ₙ} in the set Sₙ is based, at least in part, on one or more respective constraints of one or more of the constraint sets S₁, . . . , Sₙ₋₁ (i.e. one or more of the constraint sets in the sequence of constraint sets that precede the constraint set Sₙ).

At a step 806, a determination is made as to whether any more constraint sets need generating. This determination could be, for example, based on whether n equals a predetermined value—for example, the value of N_{S} could have been specified, so that the step 806 could involve determining that another constraint set needs generating if n≤N_{S} or determining that another constraint set does not need generating if n>N_{S} (or n=N_{S}+1). Alternatively, this determination could be, for example, based on whether the total number of constraints exceeds a predetermined value B for example the step 806 could involve determining that another constraint set needs generating if Σᵢ₌₁ⁿ Kᵢ<B or determining that another constraint set does not need generating if Σᵢ₌₁ⁿ Kᵢ≥B (in this case, N_{S} is not predetermined but, instead, equals the current value of n-1 when the step 806 determines that no more constraint sets need generating). It will be appreciated that other criteria could be used to determine whether or not a further constraint set needs to be generated.

If, at the step 806, it is determined that another constraint set needs to be generated, then processing continues at a step 808, at which the index value n is incremented by 1, before processing returns to the step 804.

If, however, at the step 806, it is determined that another constraint set does not need to be generated, then processing continues at a step 810, at which the animation system 406 is configured to use the sets of constraints S₁, S₂, S₃, . . . , S_{N}_{_{S}}₊₁. This shall be described in more detail shortly.

In summary, then, the method 800 generates, for the group of object parts of the virtual object 200, an ordered sequence of sets S₁, S₂, S₃, . . . , S_{N}_{_{S}}₊₁. Each set S₁, S₂, S₃, . . . , S_{N}_{_{S}}₊₁ comprises one or more respective constraints, wherein each constraint specifies a respective relationship between two or more object parts in the group of object parts, The first set S₁ in the ordered sequence of sets is a specified set of one or more constraints. The generation of the ordered sequence of sets S₁, S₂, S₃, . . . , S_{N}_{_{S}}₊₁ comprises, for each set Sₙ (n=2, . . . , N_{S}+1) in the ordered sequence of sets S₁, S₂, S₃, . . . , S_{N}_{_{S}}₊₁ other than the first set S₁ in the ordered sequence of sets S₁, S₂, S₃, . . . , S_{N}_{_{S}}₊₁, generating each constraint c_{n,1}, c_{n,2}, . . . , c_{n,K}_{ₙ} in that set Sₙ based, at least in part, on one or more of the constraints of one or more sets (S₁, S₂, . . . , Sₙ₋₁) that precede that set Sₙ in the ordered sequence of sets S₁, S₂, S₃, . . . , S_{N}_{_{S}}₊₁. Thus, the ordered sequence of sets S₁, S₂, S₃, . . . , S_{N}_{_{S}}₊₁ is a hierarchy of constraint sets, with the set S₁ as a lowest level in the hierarchy and each other constraint set Sₙ (n=2, . . . ,N_{S}) having its constraints being based, at least in part, on one or more of the constraints from one or more lower levels in the hierarchy (i.e. constraint sets S₁, S₂, . . . , Sₙ₋₁).

It will be appreciated that the method 800 illustrated in FIG. 8 is merely exemplary, and that the ordered sequence of sets S₁, S₂, S₃, . . . , S_{N}_{_{S}}₊₁ need not be generated in exactly this way. For example, the use of the index value n is optional (with this being shown in FIG. 8 merely to assist with clarity of explanation); and the step 806 could be omitted (e.g. if N_{S}=2, then embodiments could be arranged to perform the step 804 to generate S₂ and then perform the step 804 again to generate S₃, without needing to perform a test at the step 806).

Configuring the animation system 406 at the step 810 involves arranging for the animation system 406 (or at least the constraints module 404) to make use of the ordered sequence of sets S₁, S₂, S₃, . . . , S_{N}_{_{S}}₊₁.

For example, the animation system 406 may perform the methods 500 and 600 to carry out the animation of the object 200, However, instead of just using the pre-specified constraints c_{1,1}, c_{1,2}, . . . , c_{1,K}_{₁} of the initial constraint set S₁, each iteration step of the method 600 may comprises sequentially applying, in the order for the ordered sequence of sets S₁, S₂, S₃, . . . , S_{N}_{_{S}}₊₁ the sets in the ordered sequence of sets S₁, S₂, S₃, . . . , S_{N}_{_{S}}₊₁ to the group of object parts. Thus, the constraints module 406 is arranged to perform one or more iteration steps, as necessary, wherein each iteration step is arranged to apply the sets S₁, S₂, S₃, . . . , S_{N}_{_{S}}₊₁ in the ordered sequence of sets S₁, S₂, S₃, . . . , S_{N}_{_{S}}₊₁, in the order for the ordered sequence of sets S₁, S₂, S₃, . . . , S_{N}_{_{S}}₊₁, to the group of object parts.

This could be achieved, for example, by creating a new set S₁* of constraints that is the union of the sets S₁, S₂, S₃, . . . , S_{N}_{_{S}}₊₁, where the constraints in the set S₁* are ordered so that the constraints of the set Sₙ will be applied before the constraints of the set Sₙ₊₁ (n=1,. . . ,N_{S}), Indeed, if each constraint set S, (n=1, . . . , N_{S}+1) is itself an ordered set, so that the constraints c_{n,1}, c_{n,2}, . . . , c_{n,K}_{ₙ} are applied in that order (i.e. constraint c_{n,i} is applied before constraint c_{n,i+1} for i=1, . . . , Kₙ−1), then that ordering may be maintained within the set S₁*. Thus, for example, if all of the constraint sets S, (n=1, . . . , n_{S}+1) are ordered sets, then the constraint set S₁* may comprise all of the constraints from all of the sets S₁, S₂, S₃, . . . , S_{N}_{_{S}}₊₁, in the order c_{1,1}, c_{1,2}, . . . , c_{1,K}_{₁}, c_{2,1}, c_{2,2}, . . . , c_{2,K}_{₂}, c_{3,1}, c_{3,2}, . . . , c_{3,K}_{₃}, . . . , c_{N}_{_{S}}_{+1,1}, c_{N}_{_{S}}_{+1,2}, . . . , c_{N}_{_{S}}_{+1,K}_{_{NS}}₊₁. The step 810 may, then, comprise configuring the animation system 406 to use the constraint set S₁* (e.g. instead of just the constraint set S₁). In this way, the animation system 406 may not be explicitly aware of the different constraint sets S₁, S₂, S₃, . . . , S_{N}_{_{S}}₊₁—however, the animation system 406 will, by virtue of the construction of the constraint set S₁*, still sequentially apply, in the order for the ordered sequence of sets S₁, S₂, S₃, . . . , S_{N}_{_{S}}₊₁, the sets in the ordered sequence of sets S₁, S₂, S₃, . . . , S_{N}_{_{S}}₊₁, to the group of object parts. The method 600 then remains unchanged (in which case, N_{c}=Σᵢ₌₁^{N}⁺¹Kᵢ), except for the set of constraints that the animation system 406 uses (i.e. the constraint set S₁* is used instead of just the constraint set S₁).

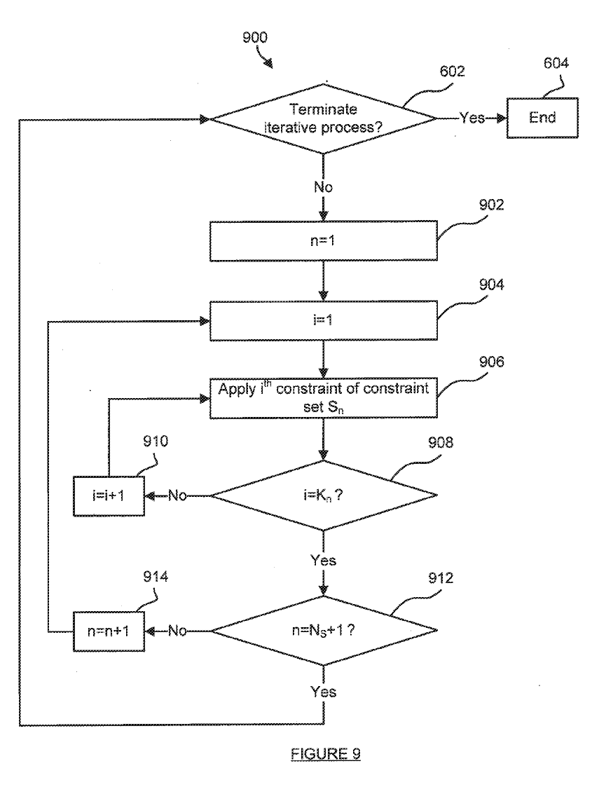

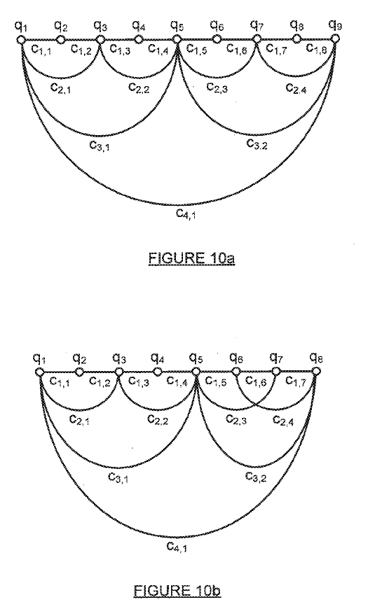

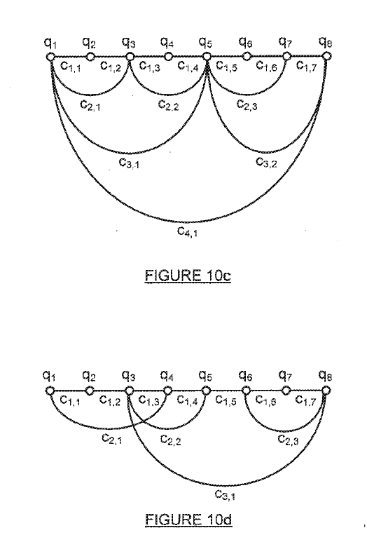

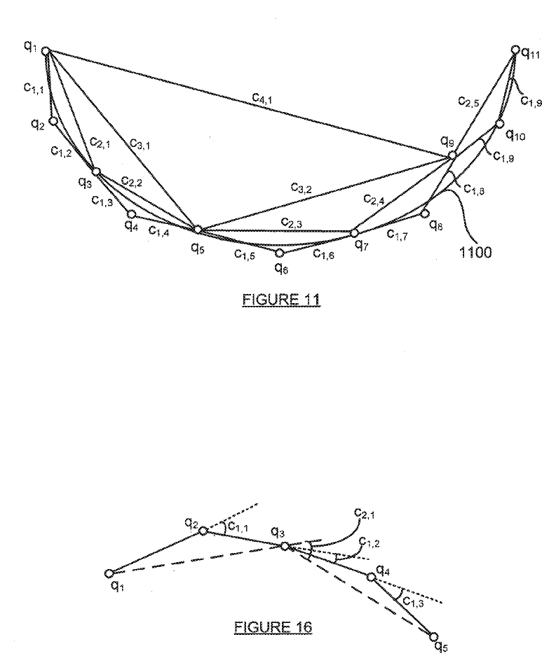

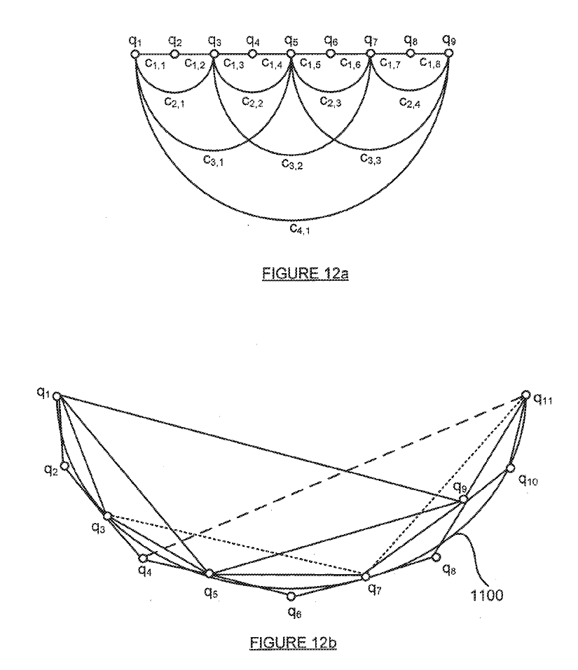

Alternatively, in some embodiments, the animation system 406 may be aware of the different constraint sets S₁, S₂, S₃, . . . , S_{N}_{_{S}}₊₁. The constraints module 404 may then implement the step 506 using an updated iteration method instead of the method 600 of FIG. 6. FIG. 9 is a flowchart illustrating such an updated iteration method 900 that may be used by the constraints module 404 to implement some embodiments (although it will be appreciated that the same functionality could be achieved using different processing, so that the method 900 illustrated in FIG. 9 is merely exemplary).

The method 900, like the method 600, is an iterative process that involves performing one or more iterations (or iteration steps) as necessary. An iteration step may involve one or more of steps 602, 604, 902, 904, 906, 908, 910, 912 and 914 shown in FIG. 9.

Thus, at the step 602, the constraints module 404 determines whether or not to terminate the iterative process (which may be terminating at a first iteration or at a subsequent iteration for this animation update step). This is performed in the same was as for the step 602 of the method 600 (hence the same numbering). If the constraints module 404 determines at the step 602 that the iterative process is to be terminated for the current animation update step, then the method 600 terminates at the step 604 (in the same was as for the method 600). Otherwise, processing continues at the step 902.

Each constraint set S, (n=1, . . . , N_{S}+1) may form an ordered set or an ordered list of constraints c_{n,1}, c_{n,2}, . . . , c_{n,K}_{ₙ} (i.e. they may be arranged as a sequence or series of constraints).

At the step 902, an index value n is initialised to be 1—here, the index value n represents the “current” constraint set (i.e. set Sₙ).

At the step 904, an index value i is initialised to be 1—here, the index value i represents the “current” constraint within the current constraint set (i.e. constraint c_{n,i}).

At the step 906, the constraints module 404 applies the current constraint c_{n,i} to the group of object parts. This may be performed in the same was as discussed above for the step 608 of FIG. 6.

At the step 908, the constraints module 404 determines whether there are any more constraints from the current constraint set Sₙ to apply to the group of object parts, e.g. by testing whether i=Kₙ. If there is at least one more constraint from the current constraint set Sₙ to apply to the group of object parts (i.e. if i<Kₙ), then processing continues at the step 910 at which i is incremented by 1, following which processing returns to the step 906; otherwise, if there are no more constraints from the current constraint set Sₙ to apply to the group of object parts (i.e. if i=Kₙ), then processing continues at the step 912.

At the step 912, the constraints module 404 determines whether there are any more constraint sets Sₙ to apply to the group of object parts, e.g. by testing whether n=N_{S}+1. If there is at least one more constraint set to apply to the group of object parts (i.e. if n<N_{S}+1), then processing continues at the step 914 at which n is incremented by 1, following which processing returns to the step 904; otherwise, if there are no more constraint sets to apply to the group of object parts q (i.e. if n=N_{S}+1), then processing returns to the step 602.

Thus, the steps 902, 904, 906, 908, 910, 912 and 914 effectively apply the constraints, as (or if) necessary (as determined at the step 602) sequentially (i.e. according to the order of the constraint sets and according to order of the constraints within each constraint set), It will, however, be appreciated that this could be achieved in different ways, without performing the particular steps 902, 904, 906, 908, 910, 912 and 914. Thus, the constraints module 406 is arranged to perform one or more iteration steps, as necessary, wherein each iteration step is arranged to apply the sets S₁, S₂, S₃, . . . , S_{N}_{_{S}}₊₁ in the ordered sequence of sets S₁, S₂, S₃, . . . , S_{N}_{_{S}}₊₁, in the order for the ordered sequence of sets S₁, S₂, S₃, . . . , S_{N}_{_{S}}₊₁, to the group of object parts.

The generation of the constraints c_{n,1}, c_{n,2}, . . . , c_{n,K}_{ₙ} in the constraint set Sₙ at the step 804 may be based, at least in part on (a) an initial order for the object parts in the group of object parts of the object 200 and/or (b) an order for the constraints in the preceding constraint sets Sᵢ (i=1, . . . ,n−1) upon which the constraints in the current constraint set Sₙ are (to be) based. For example, the N_{q} object parts may be ordered as q₁, q₂, . . . , q_{N}_{_{q}} (i.e. qᵢ occurs before qⱼ in the ordering if i<j), in which case constraints for the constraint set Sₙ that involve (or relate to) the object part qᵢ may be generated before constraints for the constraint set Sₙ that involve (or relate to) the object part qⱼ if i<j. Similarly, the constraints in the preceding constraint sets Sᵢ (i=1, . . . ,n−1) may be ordered as c_{1,1}, c_{1,2}, . . . , c_{1,K}_{₁}, c_{2,1}, c_{2,2}, . . . , c_{2,K}_{₂}, c_{3,1}, c_{3,2}, . . . , c_{3,K}_{₃}, c_{n-1,1}, c_{n-1,2}, . . . , c_{n-1,K}_{_{n−1}}, in which case a constraint c_{n,i} for the constraint set Sₙ may be generated before a constraint c_{n,j} for the constraint set Sₙ if the constraints in the preceding constraint set(s) S₁, S₂, . . . , Sₙ₋₁ upon which the constraint c_{n,j} is to be based occur later in the ordering than at least one of the constraints in the preceding constraint set(s) S₁, S₂, . . . , Sₙ₋₁ upon which the constraint c_{n,i} is to be based. It will be appreciated that embodiments may generate the constraints c_{n,1}, c_{n,2}, . . . , c_{n,K}_{ₙ} in the constraint set Sₙ in other ways based on (a) an initial order for the object parts in the group of object parts of the object 200 and/or (b) an order for the constraints in the preceding constraint sets Sᵢ (i=1, . . . ,n−1) upon which the constraints in the current constraint set Sₙ are (to be) based.

For a constraint c in the set Sₙ (n=2, . . . ,N_{S}+1), a constraint c* in a preceding constraint set (i.e. one of S₁, . . . ,Sₙ₋₁) shall be referred to as an immediate descendant of the constraint c if the generation of the constraint c at the step 804 was based, at least in part, on the constraint c*. Constraints in the set S₁ do not have any immediate descendants (since the constraints in the set S₁ are not generated at the step 804 and are, instead, pre-specified). Let R_{c} be the set of immediate descendants of the constraint c. Then let the set of descendants D_{c} of the constraint c be the set of immediate descendants R_{c} of the constraint c together with the set of descendants of any immediate descendant of the constraint c, i.e. D_{c} is defined iteratively as D_{c}=R_{c} ∪U {D_{X}:x∈R_{c}}. In some embodiments, each generated constraint c vain be a constraint that specifies a relationship between two or more object parts, where for each of those two or more object parts at least one immediate descendant of the constraint c specifies a relationship involving that object part. In this way, the constraint c may aim to impose again (at least to some extent) its immediate descendant constraints and thereby undo some error that might have been introduced since its immediate descendant constraints were last applied to the group of object parts (the error being due to subsequent application of other constraints). This helps the iterative process terminate sooner (i.e. with fewer iterations). Even though each iteration may involve applying more constraints (namely those in the generated sets S₂, S₃, . . . , S_{N}_{ₛ}₊₁) than if only the pre-specified set of constraints S₁ were used, the number of iterations can often be substantially reduced, thereby offsetting the increased number of constraints and resulting in much less computational cost for a given animation quality level. For example, for a chain of N_{q}=21 object parts (as illustrated in FIG. 2a), the iteration count could be reduced from 16 down to 4 resulting in a third of the processing cost.

In some embodiments, the constraints in the set Sₙ (n=2, . . ., N_{S}+1) are generated based on two or more constraints from the immediately preceding constraint set Sₙ₋₁.

The step 804 may generate a constraint based on other constraints in a number of ways. Examples of this are set out below, and embodiments may make use of one or more of these examples. However, it will be appreciated that embodiments may make use of other example methods, and embodiments should therefore not be taken to be limited by the following examples.

It will also be appreciated, and as will be apparent from the examples given below, that the type of a generated constraint may be different from the type(s) of the constraints used to generate that constraint. For example (and as shown in the first example below) a “maximum allowable distance” constraint may be generated based on “fixed distance constraints”. This can sometimes be used to impose a different nature on the object 200 (e.g. imposing more rigidity to the object 200 by generating fixed distance constraints). However, in preferred embodiments, the generated constraints do not affect the nature of the object 200 but serve, instead, to merely help the iterative process converge/terminate more quickly an example of this is the generation of a “maximum allowable distance” constraint based on initial “maximum allowable distance” constraints or “fixed distance” constraints as illustrated in constraint generation examples 1 and 2 below.

### Constraint Generation Example 1

Initial constraints: (i) Suppose a first constraint c_{a,b} is a “maximum allowable distance” constraint for two object parts qₓ and q_{y}, that have respective position vectors pₓ and p_{y}, that specifies that |pₓ−p_{y}|<d_{x,y} for some value d_{x,y} for those two object parts qₓ and q_{y}. Alternatively, the constraint c_{a,b} could be a “fixed distance” constraint for the two object parts qₓ and q_{y}, that specifies that |pₓ−p_{y}|=d_{x,y} for some value d_{x,y} for those two object parts qₓ and q_{y}.
(ii) Suppose a second constraint c_{p,q} is a “maximum allowable distance” constraint for the object part q_{y} and another object part q_{z} that has a position vector p_{z} that specifies that |pₓ−p_{y}|<d_{y,z} for some value d_{y,z} for those two object parts q_{y} and q_{z}. Alternatively, the constraint c_{p,q} could be a “fixed distance” constraint for the two object parts q_{y} and q_{z}, that specifies that |pₓ−p_{y}|=d_{y,z} for some value d_{y,z} for those two object parts q_{y} and q_{z}.

New constraint (i) A new constraint may be generated based on c_{a,b} and c_{p,q}, that specifies that |pₓ−p_{y}|<d_{x,z}, where d_{x,z}=f₁(d_{x,y}, d_{y,z}) for some function f₁. An example of this could be d_{x,z}=d_{x,y}+d_{y,z} or d_{x,z}=α(d_{x,y}+d_{y,z}) for some positive value α. Thus, the new constraint is a “maximum allowable distance” constraint for the two object parts qₓ and q_{z}, where the corresponding distance for this constraint is based on the distances for the constraints c_{a,b} and c_{p,q}.
(ii) Alternatively, a new constraint may be generated based on c_{a,b} and c_{p,q}, that specifies that |pₓ−p_{z}|<d_{x,z}, where d_{x,z}=f₂(d_{x,y}, d_{y,z}) for some function f₂. An example of this could be d_{x,z}=d_{x,y}+d_{y,z} or d_{x,z}=α(d_{x,y}+d_{y,z}) for some positive value α. Thus, the new constraint is a “fixed distance” constraint for the two object parts qₓ and q_{z}, where the corresponding distance for this constraint is based on the distances for the constraints c_{a,b} and c_{p,q}. As mentioned above, the generation of such “fixed distance” constraints may itself then impose more rigidity on the object 200—i.e. the object 200 may have had a degree of flexibility under the initial set of constraints S₁, but newly generated “fixed distance” constraints may then limit this flexibility.

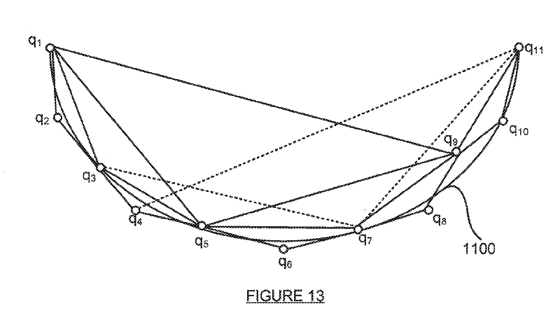

FIG. 10a schematically illustrates this example of generating constraints. In this example group of object parts, there are 9 object parts q₁, q₂, . . . , q₉, with respective position vectors p₁, p₂, . . . , p₉. The initial set of constraints S₁ comprises 8 constraints c_{1,1}, . . . ,c_{1,8}, where c_{1,i} is a constraint (of the type set out above as “initial” constraints) between the object parts qᵢ and qᵢ₊₁. The step 804 may, therefore, involve:
Generating the constraint set S₂ by processing pairs of constraints from the constraint set S₁, thereby generating 4 constraints c_{2,1}, . . . ,c_{2,4}, where c_{2,i} is generated based on and c_{1,2i-1} (i=1, . . . ,4) as set out above. The pairs of constraints from the constraint set S₁ may be processed based on the order for the constraints in the constraint set S₁ (i.e. pair c_{1,2i-1}, and c_{1,2i} before pair c_{1,2i+1} and c_{1,2i+2}).
Generating the constraint set S₃ by processing pairs of constraints from the constraint set S₂ analogously, thereby generating 2 constraints c_{3,1} and c_{3,2}, where C_{3,i}, is generated based on c_{2,2i-1} and c_{2,2i} (i=1, 2) as set out above, The pairs of constraints from the constraint set δ₂ may be processed based on the order for the constraints in the constraint set S₂ (i.e., pair c_{2,2i-1} and c_{2,2i} before pair c_{2,2i+1} and c_{2,2i4+2}).
Generating the constraint set S₄ by processing pairs of constraints from the constraint set S₃ analogously, thereby generating 1 constraint c_{4,1} based on c_{3,1} and c_{3,2} as set out above.
The constraints may then be processed or applied by the constraints module 404 at the step 506 in the order c_{1,1}, . . . ,c_{1,8}, c_{2,1}, . . . ,c_{2,4}, c_{3,1}, c_{3,2}, c_{4,1}.

FIG. 10b schematically illustrates this example of generating constraints. In this example group of object parts, there are 8 object parts q₁, q₂, . . . , q₈, with respective position vectors p₁, p₂, . . . , p₈. The initial set of constraints S₁ comprises 7 constraints c_{1,1}, . . . ,c_{1,7}, where c_{1,i} is a constraint (of the type set out above as “initial” constraints) between the object parts qᵢ and qᵢ₊₁. The step 804 may involve generating constraint sets S₂, S₃ and S₄ as discussed above for FIG. 10a, except that, due to the number of object parts, the constraint c₂.₄ may be generated based on the constraints c_{1,6} and c_{1,7}.

FIG. 10c schematically illustrates this example of generating constraints. In this example group of object parts, there are 8 object parts q₁, q₂, . . . , q₈, with respective position vectors p₁, p₂, . . . , p₈. The initial set of constraints S₁ comprises 7 constraints c_{1,1}, . . . ,c_{1,7}, where c_{1,i} is a constraint (of the type set out above as “initial” constraints) between the object parts qᵢ and gᵢ₊₁. The step 804 may involve generating constraint sets S₂, S₃ and S₄ as discussed above for FIG. 10a, except that, due to the number of object parts, the constraint c_{2,4} is not generated and the constraint c_{3,2} is generated based on the constraints c_{2,3} and c_{1,7}.

It will be appreciated that this example of generating constraints applies equally to other configurations of object parts (and not just 1-dimensional objects 200, but also objects with different numbers of dimensions, such as those shown in FIGS. 2b, 2c and 2d). Similarly, it will be appreciated that, for any given group of object parts, a number of different constraint sets could be generated using this example of generating constraints.

### Constraint Generation Example 2

Initial constraints Suppose there is a sequence of w+1 object parts qₙ_{₁}, qₙ_{₂}, . . . , qₙ_{_{w+1}} of the object 200 (for some w>1 and indices n₁, . . . , n_{w+1} for the object parts of the object 200), that have respective position vectors pₙ_{₁}, pₙ_{₂}, . . . , pₙ_{_{w+1}}. Suppose that, for each a=1, . . . ,w there is a constraint cᵤ_{_{a,}}ᵥ_{ₐ} (the vₐ^{th} constraint in the uₐ^{th} constraint set Sᵤ_{ₐ}) between object parts qₙ_{ₐ} and qₙ_{ₐ₊₁}, where cᵤ_{_{a,}}ᵥ_{ₐ} is either (a) a “maximum allowable distance” constraint for object parts qₙ_{ₐ} and qₙ_{ₐ₊₁} that specifies that |pₙ_{ₐ}−pₙ_{ₐ₊₁}|<dₐ or that |pₙ_{ₐ}−pₙ_{ₐ₊₁}|≤dₐ for some value dₐ for those two object parts qₙ_{ₐ} and qₙ_{ₐ₊₁}; or (b) a “fixed distance” constraint for object parts qₙ_{ₐ} and qₙ_{ₐ₊₁} that specifies that |pₙ_{ₐ}−pₙ_{ₐ₊₁}|=dₐ for some target value dₐ for those two object parts qₙ_{ₐ} and qₙ_{ₐ₊₁}; or a “minimum allowable distance” constraint for object parts qₙ_{ₐ} and qₙ_{ₐ₊₁} that specifies that |pₙ_{ₐ}−pₙ_{ₐ₊₁}|<dₐ or that |pₙ_{ₐ}−pₙ_{ₐ₊₁}|≤dₐ for some value dₐ for those two object parts qₙ_{ₐ} and qₙ_{ₐ₊₁}.
New constraint A new constraint may be generated, for the pair of object parts qₙ_{₁} and qₙ_{_{w+1}}, based on the constraints cᵤ_{_{a,}}ᵥ_{ₐ} (a=1, . . . ,w) that specifies that |pₙ_{₁}−pₙ_{_{w+1}}|<d_{new} or |pₙ_{₁}−pₙ_{_{w+1}}|≤d_{new} or |p₁−p_{w}|=d_{new} or |pₙ_{₁}−pₙ_{_{w+1}}|<d_{new} or |pₙ_{₁}−pₙ_{_{w+1}}|≥d_{new} where d_{new}=f(d₁, d₂, . . . , d_{w})for some function f. An example of this could be d_{new}=Σₐ₌₁^{w}dₐ or d_{new}=αΣₐ₌₁^{w}dₐ for some positive value α.

The above first example of constraint generation is a specific version (with w=2) of this more generalised example of constraint generation, It will, however, be appreciated that embodiments may generate constraints from other “previous” constraints in different ways.

For example, FIG. 10d schematically illustrates this example of generating constraints. In this example group of object parts, there are 8 object parts q₁, q₂, . . . , q₈, with respective position vectors p₁, p₂, . . . , p₈. The initial set of constraints S₁ comprises 7 constraints c_{1,1}, . . . , c_{1,7}, where c_{1,i} is a constraint (of the type set out above as “initial” constraints) between the object parts qᵢ and gᵢ₊₁. The step 804 may involve:
Generating the constraint set S₂. In this example, S₂ comprises three constraints, c_{2,1}, c_{2,2} and c_{2,3}. c_{2,1} is generated as set out above based on c_{1,1}, c_{1,2} and c_{1,3}, so that it is a constraint on object parts q₁ and q₄; c_{2,2} is generated as set out above based on c_{1,3} and c_{1,4}, so that it is a constraint on object parts q₃ and q₅; and c_{2,3} is generated as set out above based on c_{1,6} and c_{1,7}, so that it is a constraint on object parts q₆ and q₈.
Generating the constraint set S₃. In this example, S₃ comprises one constraint, c_{3,1}, which is generated as set out above based on c_{2,2}, c_{1,5} and c_{2,3}, so that it is a constraint on object parts q₃ and q₈.
The constraints may then be processed or applied by the constraints module 404 at the step 506 in the order c_{1,1}, . . . , c_{1,7}, c_{2,1}, c_{2,2}, c_{2,3}, c_{3,1}.

Thus, in general, in some embodiments, at least one constraint c of at least one set Sₙ (n=2, . . . , N_{S}+1) in the ordered sequence of sets other than the first set S₁ in the ordered sequence of sets is based on a corresponding number w of respective constraints c₁, . . . ,c_{w} of one or more sets (S₁, . . . , Sₙ₋₁) that precede said at least one set Sₙ in the ordered sequence of sets, wherein w is an integer greater than 1, wherein for each α=1, . . . ,w, the constraint cₐ specifies a relationship between an object part qₙ_{ₐ} and an object part qₙ_{ₐ₊₁}, wherein said at least one constraint c is a constraint that specifies a relationship between the object part q₁ and the object part q_{w+1}.

Again, it will be appreciated that this example of generating constraints applies equally to other configurations of object parts (and not just 1-dimensional objects 200, but also objects with different numbers of dimensions, such as those shown in FIGS. 2b, 2c and 2d). Similarly, it will be appreciated that, for any given group of object parts, a number of different constraint sets could be generated using this example of generating constraints.

### Potential “Distribution Problem”

FIG. 11 schematically illustrates a potential undesirable artefact in the animation of the object 200 (referred to herein as a “distribution problem”) that may arise in some embodiments. The intention in the example illustrated in FIG. 11 is to simulate an object 200 that is a rope by using 11 object parts q₁, q₂, . . . , q₁₁. The intended smooth curve of the rope is illustrated by the curved line 1100. The set of initial constraints S₁ has constraints c_{1,n} (n=1, . . . , 10), where c_{1,n} is a “maximum allowable distance” constraint for the pair of object parts qₙ and qₙ₊₁. Using the constraint generation technique of the above-described constraint generation example 1:the set S₂ comprises constraints c_{2,n} (n=1, . . . ,5), where c_{2,n} is a “maximum allowable distance” constraint for the object parts q₂ₙ₋₁ and q₂ₙ₊₁; the set S₃ comprises constraints c_{3,n} (n=1, 2), where c_{3,n} is a “maximum allowable distance” constraint for the object parts q₄ₙ₋₃ and q₄ₙ₊₁; the set S₄ comprises a single constraint c_{4,1} which is a “maximum allowable distance” constraint for the object parts q₁ and q₈. As can be seen from FIG. 11, the object parts q₁, . . . , q₁₁ do not follow a smooth curve—object part q₉, for example, represents a “kink” in the rope, i.e. the object part q_{g} is substantially further away from the desired smooth curve 1100 than the other object parts. This is likely to be due to the constraints c_{4,1} and c_{3,2} moving the object part q₉—and here, the constraints c_{4,1} and c_{3,2} are themselves being applied due to the constraints in the initial constraint set S₁ not all being satisfied (e.g. if not enough iteration steps have been performed yet so as to converge on a solution for the object parts q₁, . . . ,q₁₁ that satisfies the constraints in the initial constraint set S₁).

This potential distribution problem may be addressed by embodiments in a number of different ways, as discussed below.

### Constraint Generation Example 3

As can be seen from FIGS. 10a-10d, the above-described constraint generation examples 1 and 2 can lead to newly generated constraints that relate to object parts that are quite far apart from each other (compared to how far apart the object parts are to which a constraint in the initial constraint set S₁ relates). This distance will tend to increase for constraints sets further up the hierarchy (i.e. the distance will tend to increase for constraints c_{n,k} in the constraint set Sₙ as n gets larger). Looking, for example, at FIG. 10a, the constraint c_{4,1} relates to object parts q₁ and q₉ that are significantly further apart than the object parts qᵢ and qᵢ₊₁ to which the constraint c_{1,i} relates (i=1, . . . ,8). This is one of the contributing factors that can lead to the above-mentioned distribution problem,

In some embodiments, the object parts are considered as forming an ordered sequence of object parts q₁, q₂, . . . , q_{N}_{_{q}}. Then, each generated constraint set Sₙ (n=2, . . . ,N_{S}+1) may have each of its constraints generated in any way as discussed above. However, in this example, one or more of the constraint sets Sₙ (n=2, . . . ,N_{S}+1) is generated so that if a constraint c_{n,i} is generated for the constraint set Sₙ that specifies a relationship between two object parts qₐ and qₐ₊ᵣ (i.e. two object parts that are r apart in the sequence of object parts q₁, q₂, . . . , q_{N}_{_{q}}), then if r exceeds some threshold T (e.g. T=2), then a constraint c_{n,j} is also generated (if possible) for the constraint set Sₙ that specifies a relationship between the object part q_{q+T} (or potentially any one of qₐ₊₁, . . . ,q_{a+T-1}) and some other object part. The threshold value T may be the same for all constraint sets Sₙ (n=2, . . . ,N_{S}+1) or may be specific to each constraint set Sₙ (n=2, . . . ,N_{S}+1). Put another way, for at least one set Sₙ in the ordered sequence of sets other than the first set S₁ in the ordered sequence of sets, generating the constraints for that set Sₙ comprises ensuring that if a constraint is generated specifying a relationship for a first object part and a second object part that are more than a predetermined distance (T) apart in an ordering for the group of object parts, then a further constraint is generated if possible for a third object part and a fourth object part, wherein the third object part and the first object part are no more than the predetermined distance part in the ordering for the group of object parts.

FIG. 12a schematically illustrates this example of generating constraints, where T=2.This is the same as FIG. 10a, except that the constraint set S₃ now comprises three constraints c_{3,1}, c_{3,2} and c_{3,3}. In particular, c_{3,1} is generated based on c_{2,1} and c_{2,2} and is a constraint for object parts q₁ and q₅ (=q₁₊₄). Instead of simply moving to generate a constraint based on the next pair of constraints in the constraint set S₂ (i.e. based on the constraints c_{2,3} and c_{2,4}), as was done in FIG. 10a, since (5−1)>T, in this embodiment, the next constraint c_{3,2} to be generated is based on c_{2,2} and c_{2,3} so that there is a constraint for object part q_{1+T}=q₃ and another object part (q₇ in this example). The next constraint c_{3,3} in the constraint set S₃ may be generated analogously.

FIG. 12b schematically illustrates this example of generating constraints, again where T=2, when applied to the object 200 shown in FIG. 11. As can be seen, additional constraints have been included in the constraint set S₃ (shown as dotted lines) and an additional constraint has been included in the constraint set S₄ (shown as a dashed line). These help overcome the distribution problem mentioned above.

### Constraint Generation Example 4

As described above, for some distance constraints, a new distance is calculated. In constraint generation example 1 above, this newly calculated distance may be d_{x,z}=α(d_{x,y}+d_{y,z}); in constraint generation example 2 above, this calculated distance may be d_{new}=αΣₐ₌₁^{w-1}dₐ. In some embodiments (which may operate in the same way as constraint generation examples 1, 2 or 3 above), the newly calculated distance is generated using a value of a that is greater than 1. This means that the newly generated constraints represent a slightly more relaxed or increased rest length for the object parts. This helps overcome the above-mentioned distribution problem for example, the constraint c_{4,1} shown in FIG. 11 would have a longer associated distance for a larger value of α, meaning that the object part q₉ would not be pulled away from the desired smooth curve 1100 quite so much. Indeed, in some embodiments, the value of a changes from constraint set to constraint set, so that the value of α is larger for constraint set Sₙ₊₁ than it is for constraint set Sₙ (n=1, . . . ,N_{S}).

### Constraint Generation Example 5

As mentioned above, the generation of the constraints c_{n,1}, c_{n,2}, . . . , c_{n,K}_{ₙ} in the constraint set Sₙ (n=2, . . . ,N_{S}+1) at the step 804 may be based, at least in part on (a) an initial order for the object parts in the group of object parts of the object 200 and/or (b) an order for the constraints in the preceding constraint sets Sᵢ (i=1, . . . ,n−1) upon which the constraints in the current constraint set Sₙ are (to be) based. This can, however, lead to a lack of symmetry (in terms of certain object parts having more constraints imposed upon them by the generated sets Sₙ (n=2, . . . ,N_{S}+1) than other object parts).

This may then contribute towards the above-mentioned distribution problem. For example, in FIG. 11, the constraints are generated for the constraint sets S₂, S₃ and S₄ based on the ordering of the object parts q₁, q₂, . . . ,q₁₁. As can be seen, this results in the object part q₉ having more constraints imposed upon it than any of the other object parts.

Therefore, in some embodiments, the constraints generated for a constraint set Sₙ (n=2, . . . ,N_{S}+1) may be generated based on an initial order for the object parts in the group of object parts of the object 200 and with additional constraints being generated based on the inverse of that order. Additionally or alternatively, in some embodiments, the constraints generated for a constraint set Sₙ (n=2, . . . ,N_{S}+1) may be generated based on an order for the constraints in the preceding constraint sets S_{i (i=}1, . . . , n−1) upon which the constraints in the current constraint set Sₙ are (to be) based and with additional constraints being generated based on an inverse of that order.

This, in some embodiments, for at least one set Sₙ in the ordered sequence of sets other than the first set S₁ in the ordered sequence of sets, a first subset of constraints in that set Sₙ are generated based on a predetermined ordering of the object parts in the group of object parts and a second subset of constraints in that set Sₙ are generated based on a second ordering of the object parts in the group of object parts, wherein the second ordering of the object parts in the group of object parts is based on the predetermined ordering of the object parts in the group of object parts (e.g. a reversed/inversed version of the predetermined ordering of the object parts in the group of object parts).

This is illustrated schematically in FIG. 13, which shows how additional constraints (shown as dotted lines) are generated when additional constraints are generated based on the inverse order for the object parts, i.e. if constraints are additionally generated based on the ordering of the object parts q₁₁,q₁₀, . . . ,q₁.

As an alternative, in some embodiments, the constraints generated for a constraint set Sₙ (n=2, . . . ,N_{S}+1) may be generated based on (a) a modified version of the initial order for the object parts in the group of object parts of the object 200 and/or (b) a modified version of the order for the constraints in the preceding constraint sets Sᵢ (i=1, . . . ,n−1). For example, instead of generating constraints for the constraint set Sₙ based on the initial ordering q₁, q₂, . . . , q_{N}_{_{q}} for the object parts, the constraints for the constraint set S, may be generated based on a modified ordering for the object parts, namely q₁, q_{N}_{_{q}}, q₂, q_{N}_{_{q}}₋₁, . . . . With this modified ordering, the constraints for the constraint set S, are built up sequentially from either end of the sequence of object parts.

Put another way, in some embodiments, the group of object parts have a predetermined ordering and, for at least one set Sₙ in the ordered sequence of sets other than the first set S₁ in the ordered sequence of sets, the constraints in that set Sₙ are generated based on a modified version of the predetermined ordering of the object parts in the group of object parts.

Embodiments may implement the method 900 in a number of alternative ways. Examples of this are set out below, and embodiments may make use of one or more of these examples. However, it will be appreciated that embodiments may make use of other example methods, and embodiments should therefore not be taken to be limited by the following examples.

### Constraint Application Example 1

As mentioned above, a constraint represents, or specifies or imposes, a respective relationship between two or more object parts in the group of object parts. Suppose, for example, that a constraint c_{n,i} relates to w object parts qₙ_{₁}, qₙ_{₂}, . . . , qₙ_{_{w}}, then the application of that constraint involves modifying or updating one or more of those object parts w object parts qₙ_{₁}, qₙ_{₂}, . . . , qₙ_{_{w}}. The w object parts q₁, q₂, . . . , q_{N}_{_{q}}. may not necessarily be consecutive in the initial ordering q₁, q₂, . . . , q_{N}_{_{q}} for the object parts, i.e. if we assume that nᵢ<nᵢ₊₁ for i=1, . . . ,w−1, then there might be a value for i so that nᵢ₊₁≈nᵢ+1, so that there is an object part qₐ between the object parts q₁. and gₙ_{ᵢ₊₁} in the initial ordering q₁, q₂, . . . , q_{N}_{_{q}} for the object parts. Thus, in some embodiments, the application of a constraint may involve modifying or updating one or more of the object parts qₙ_{₁}, qₙ_{₁}₊₁, . . . , qₙ_{_{w}}, i.e. potentially updating one or more object parts qₐ between object parts qₙ_{₁} and qₙ_{_{w}}. other than the object parts between which the constraint c_{n,i} specifies a relationship.

For example, in some embodiments, the application of the constraint c may involve updating all of the object parts for which a relationship is specified by at least one of (a) the constraint c and (b) any of the immediate descendants of the constraint c.

As another example, in some embodiments, the application of the constraint c may involve updating all of the object parts for which a relationship is specified by at least one of (a) the constraint c and (b) any of the descendants of the constraint C.

Referring, for example, to the example of FIG. 10a. The immediate descendants of the constraint c_{3,1} are the constraints c_{2,1} and c_{2,2}. Thus, in some embodiments, application of the constraint c_{3,1} may involve modifying the object parts to which the constraint c_{3,1} relates (namely the object parts q₁ and q₅) and modifying the object parts to which the constraints c_{2,1} and c_{2,2} relate (namely the object parts q₁, q₃ and q₅), so that, in total, one or more of the object parts q₁, q₃ and q₅ may be modified. Similarly, the descendants of the constraint c_{3,1} are the constraints c_{2,1}, c_{2,2}, c_{1,1}, c_{1,2}, c_{1,3} and c_{1,4}. Thus, in some embodiments, application of the constraint c_{3,1} may involve modifying the object parts to which the constraint c_{3,1} relates (namely the object parts q₁ and q₅) and modifying the object parts to which the constraints c_{2,1}, c_{2,2}, c_{1,1}, c_{1,2}, c_{1,3} and c_{1,4} relate (namely the object parts q₁, . . . , q₅), so that, in total, one or more of the object parts q₁, . . . , q₅ may be modified.

Use of this example of application of constraints helps address the above-mentioned distribution problem.

Modification of the object parts may be achieved as described above (e.g. so as to maintain the centre of mass of those object parts). In some embodiments, the object parts that are modified other than those to which the constraint relates may be modified to a reduced degree than the modification applied to the object parts to which the constraint relates. For example, in the above embodiment in which application of the constraint c_{2,2} involves modifying the object part q₄ in addition to modifying the object parts q₃ and q₅, the object part q₄ may be moved by a fraction of the displacement of the object parts q₃ and q₅. If, for example, the object parts q₃, q₄ and q₅ all have the same mass (i.e. their associated mass attributes have the same value), then the displacement of the object part q₄ could be set to be the mean of the displacements of the object parts q₃ and q₅. If the object parts q₃, q₄ and q₅ have different masses, then the respective displacements of those object parts can be modified accordingly, for example to preserve the overall centre of mass of those object parts.

As an example, suppose a constraint c specifies a relationship between two object parts qₙ_{₁} and qₙ_{ᵥ}, but that application of the constraint is also to update (or move or influence) a number (v−2) of other object parts qₙ_{₂}, qₙ_{₃}, . . . , qₙ_{_{v−1}}. For example, in FIG. 11, the constraint c_{3,1} may specify a relationship between the object parts q₁ and q₅, and the constraint c_{3,1} may specify that it will additionally influence the object parts q₂, q₃ and q₄. For each of these object parts qᵢ (i=n₁, n₂, . . . , nᵥ), the constraint c may specify or identify a corresponding weight wᵢ for that object part. For example, the constraint c_{3,1} may specify weights w₁=−1, w₂=−0.4, w₃=−0.2, w₄=0.5 and w₅=1. Preferably, wₙ_{₁}=−1 and wₙ_{ᵥ}=1, and each other weight is greater than −1 and less than 1. For each of these object parts qᵢ (i=n₁,n₂, . . . ,nᵥ), let the associated mass of that object part be mᵢ. Let \vec{d} be the displacement vector that would have to be applied to the object part qₙ_{ᵥ} to move or update the object part qₙ_{ᵥ} (assuming that gₙ_{₁} were not updated) so that the constraint c is satisfied. Then each of the object parts qᵢ (i=n₁,n₂, . . . ,nᵥ) may be displaced by an associated displacement vector where

$$\vec{{d}_{i}} = \frac{{w}_{i}}{{m}_{i}} ( \frac{{m}_{1} {m}_{nv}}{{m}_{1} + {m}_{nv}} ) \vec{d} .$$

It will, of course, be appreciated that there are other ways in which the application of a constraint c may involve updating object parts other than the object parts between which the constraint c specifies a relationship.

### Constraint Application Example 2

In the embodiment shown in FIG. 9, the constraints of the constraint set Sₙ (for each n=1, . . . ,N_{S}+1) are applied in the order c_{n,1}, c_{n,2}, . . . , c_{n,K}_{ₙ}. In some embodiments, for at least one of the constraint sets Sₙ this order may be changed (e.g. reversed) for certain iterations (e.g. for even iterations). In particular, the order in which the constraints c_{n,1}, c_{n,2}, . . . , c_{n,K}_{ₙ} are applied may be dependent on which iteration step is being performed.

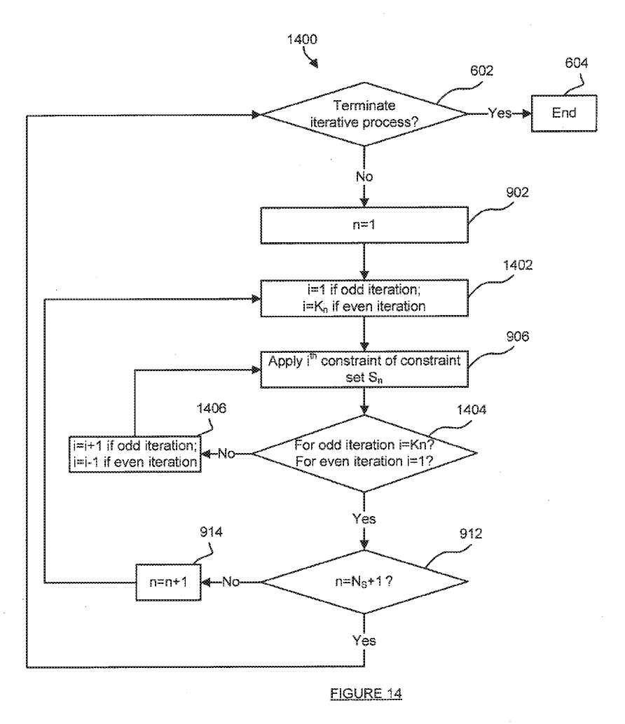

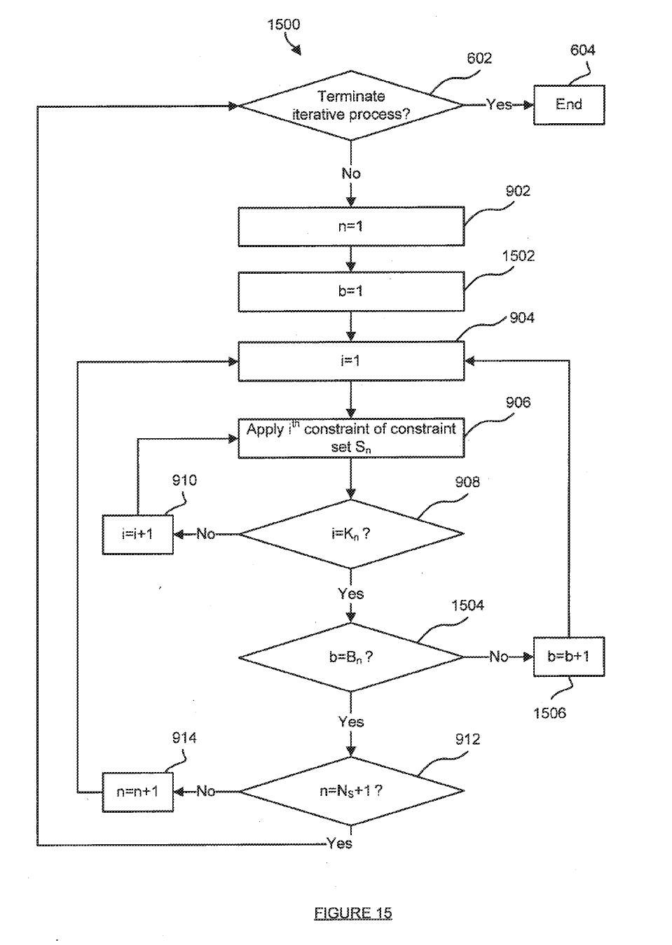

For example, for an even numbered iteration step, the order for applying the constraints in a set Sₙ may be a reverse of the order for applying the constraints in that set Sₙ for an odd numbered iteration step. An example of this is illustrated schematically in FIG. 14, which is a flowchart showing a method 1400 that is the same as the method 900 of FIG. 9, except that the steps 904, 908 and 910 are replaced by steps 1402, 1404 and 1406 respectively, as set out below:
The step 1402 sets the index i to be i=1 for odd iterations and to be i=Kₙ (instead of i=1) for even iterations.
The step 1404 tests whether i=Kₙ for odd iterations and tests whether i=1 (instead of testing whether i=Kₙ) for even iterations.
The step 1406 increments i by 1 for odd iterations and decrements i by 1 instead for even iterations.

It will be appreciated, however, that other modified orderings could be used (not just reversing the ordering) and at different iterations (not necessarily based on whether the current iteration is an odd iteration or an even iteration).

### Constraint Application Example 3

In the embodiment shown in FIG. 9, each iteration is arranged to apply the constraint set S, (n=1,. . . ,N_{S}+1) once. In some embodiments, each constraint set (n=1, . . . ,N_{S}+1) may be applied a respective number Bₙ times (where Bₙ is a positive integer) before either (a) moving on to apply the next constraint set (for n≤N_{S}) or (b) ending the current iteration (for n=N_{S}+1). Preferably, Bₙ≥Bₙ₊₁ for n=1, . . . ,N_{S} (i.e. constraint sets lower in the hierarchy are applied at least as often as constraint sets higher in the hierarchy). If all of the B_{n (n=}1, . . . ,N_{S}+1) equal 1, then the effective processing performed is the same as that of FIG. 9. However, in some embodiments, at least one Bₙ is greater than 1. Thus, in some embodiments, for at least one set Sₙ in the ordered sequence of sets, each iteration step is arranged to apply that set Sₙ consecutively a respective predetermined number Bₙ of times, said predetermined number Bₙ being greater than 1. Indeed, the value of Bₙ may be dependent on which iteration is being performed.

An example of this is illustrated schematically in FIG. 15, which is a flowchart showing a method 1500 that is the same as the method 900 of FIG. 9, except as follows:
The method 1500 comprises a step 1502, between the steps 902 and 904. At the step 1502, an index value b is initialised to be 1—here, the index value b represents the “current” application of the current constraint set (i.e. set Sₙ),
If, at the step 908, it is determined that all of the constraints in the current constraint set have been applied to the group of object parts (e.g. if i=Kₙ), then processing continues at a step 1504 instead of at the step 912. At the step 1504, it is determined whether the current constraint set Sₙ has been applied the corresponding number Bₙ of times for the current iteration (e.g. whether b=Bₙ). If it is determined that the current constraint set Sₙ has not been applied the corresponding number Bₙ of times for the current iteration, the processing continues at a step 1506 at which the index b is incremented by 1 before processing returns to the step 904; otherwise, processing continues at the step 912.

It will be appreciated that the modifications made to the method 900 to arrive at the method 1400 could also be made to the method 1500.

### Other Types of Constraints

The example constraints discussed above are mainly distance constraints. Embodiments may operate with other kinds of distance constraint and embodiments may make use of constraints other than distance constraints.

For example, FIG. 16 schematically illustrates angular (or bending) constraints. An angular constraint relates to three object parts qₓ, q_{y} and q_{z}. Let θ_{y} be an angle between a straight line joining the object parts qₓ and q_{y} and a straight line joining the object parts q_{y} and q_{z}. An angular constraint for the object parts qₓ, q_{y} and q_{z} could then specify, for example:
A fixed angle constraint: namely, a fixed value for θ_{y} should be maintained, i.e. θ_{y}=φ_{y} for some value φ_{y}.
A maximum allowable angle constraint: namely, a maximum allowable value for θ_{y} (representing a maximum degree of bendability) e.g. i.e. θ_{y}<φ_{y} or θ_{y}≤φ_{y} for some value φ_{y}.
A minimum allowable angle constraint: namely, a minimum allowable value for θ_{y} (representing a minimum degree of bending) e.g. i.e. θ_{y}>φ_{y} or θ_{y}≥φ_{y} for some value φ_{y},
A range or set of allowable angles for θ_{y}.
Some other criterion based on e_{y}.

For example, FIG. 16 schematically illustrates a group of 5 object parts q₁, q₂, . . . , q₅. The initial set of constraints S₁ comprises 3 angular constraints c_{i,1}, c_{1,2}, c_{1,3}, where c_{1,i} (i=1, 2, 3) is a fixed value angle constraint, or a maximum allowable angle constraint or a minimum allowable angle constraint, for the object parts qᵢ, qᵢ₊₁ and qᵢ₊₂ (i.e. for the angle between the straight line joining qᵢ and qᵢ₊₁ and the straight line joining qᵢ₊₁ and qᵢ₊₂) with respective constraint angle value φᵢ₊₁. Then a new angle constraint c_{2,1} (which could be a fixed value angle constraint, or a maximum allowable angle constraint or a minimum allowable angle constraint) for the object parts q₁, q₃ and q₅ (i.e. for the angle between the straight line joining q₁ and q₃ and the straight line joining q₃ and q₅) with a respective constraint angle value of φ₂+φ₃+φ₄ may be generated for the constraint set S₂.

A constraint could relate to the (simulated) temperature of the object 200 at the object parts in the group of object parts. The temperate attributes of the object parts may be updated, based on constraints, in a similar manner to updating positions of object parts. For example, a maximum temperature constraint may specify a maximum allowable difference between the temperatures of two object parts.

A constraint could relate to the (simulated) amount of damaged that has been done to the object 200 at the object parts in the group of object parts (the damage may be a scalar value measured on some scale of damage). The damage attributes of the object parts may be updated, based on constraints, in a similar manner to updating positions of object parts. For example, a maximum damage constraint may specify a maximum allowable difference between the amounts of damage at two object parts.

A constraint could relate to a colour of the object 200 at the object parts in the group of object parts. The colour attributes of the object parts may be updated, based on constraints, in a similar manner to updating positions of object parts. For example, a maximum colour constraint may specify a maximum allowable difference between the colours at two object parts.

### 3—Examples

Various examples are set out below:

### Example 1

A computer-implemented method of configuring animation of a virtual object, wherein the method comprises:

generating and storing in a memory, for a group of object parts of the virtual object, an ordered sequence of at least two data sets, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein said generating comprises, for each data set in the ordered sequence of data sets other than the first data set in the ordered sequence of data sets, generating each constraint in said data set based, at least in part, on one or more respective constraints of one or more data sets that precede said data set in the ordered sequence of data sets; and

configuring an animation system to animate the virtual object, wherein animation of the virtual object comprises a processor of the animation system performing a series of update steps, wherein each update step comprises:
for each object part in the group of object parts, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.

Example 2

The method of example 1, wherein, for at least one data set in the ordered sequence of data sets other than the first data set in the ordered sequence of data sets, said generating each constraint in said at least one data set in the ordered sequence of data sets comprises ensuring that if a constraint is generated specifying a relationship for a first object part and a second object part that are more than a predetermined distance apart in an ordering for the group of object parts, then a further constraint is generated if possible for a third object part and a fourth object part, wherein the third object part and the first object part are no more than the predetermined distance part in the ordering for the group of object parts.

### Example 3

The method of example 1 or 2, wherein, for at least one data set in the ordered sequence of data sets other than the first data set in the ordered sequence of data sets, a first subset of constraints in said at least one data set in the ordered sequence of data sets are generated based on a predetermined ordering of the object parts in the group of object parts and a second subset of constraints in said at least one data set in the ordered sequence of data sets are generated based on a second ordering of the object parts in the group of object parts. wherein the second ordering of the object parts in the group of object parts is based on the predetermined ordering of the object parts in the group of object parts.

### Example 4

The method of example 1 or 2, wherein the group of object parts have a predetermined ordering and wherein, for at least one data set in the ordered sequence of data sets other than the first data set in the ordered sequence of data sets, the constraints in said at least one data set in the ordered sequence of data sets are generated based on a modified version of the predetermined ordering of the object parts in the group of object parts.

### Example 5

A computer-implemented method of animating a virtual object, wherein the method comprises:

performing, with a processor of an animation system, a series of update steps for a group of object parts of the virtual object, wherein the group of object parts has an associated ordered sequence of at least two data sets stored in a memory of the animation system, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein, for each data set in the ordered sequence of data sets other than the first data set in the ordered sequence of data sets, each constraint in said data set is based, at least in part, on one or more respective constraints of one or more data sets that precede said data set in the ordered sequence of data sets, wherein each update step comprises:
for each object part in a group of object parts of the virtual object, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.

### Example 6

The method of any one of examples 1 to 5, wherein each iteration step comprises:

determining whether to terminate the iterative process;

if the iterative process is not to be terminated, applying the data sets in the ordered sequence of data sets, in the order for the ordered sequence of data sets, to the group of object parts terminating the iterative process.

### Example 7

The method of example 6, wherein determining whether to terminate the iterative process comprises determining to terminate the iterative process if a predetermined number of iteration steps have been performed for said update step.

### Example 8

The method of example 6 or 7, wherein determining whether to terminate the iterative process comprises determining to terminate the iterative process if the group of object parts satisfies a predetermined number of constraints from the data sets in the ordered sequence of data sets.

### Example 9

The method of example 6 or 7, wherein determining whether to terminate the iterative process comprises determining to terminate the iterative process if the group of object parts satisfies a predetermined proportion of constraints from the data sets in the ordered sequence of data sets.

### Example 10

The method of any one of examples 1 to 9, wherein at least one constraint c of at least one data set in the ordered sequence of data sets other than the first data set in the ordered sequence of data sets is based on a corresponding number w of respective constraints of one or more data sets that precede said at least one data set in the ordered sequence of data sets, wherein w is an integer greater than 1, wherein for each i=1, . . . ,w, the constraint c, specifies a relationship between an object part qᵢ and an object part qᵢ₊₁, wherein said at least one constraint c is a constraint that specifies a relationship between the object part q₁ and the object part q_{w+1}.

### Example 11

The method of example 10, wherein:

for each i=1, . . . ,w, the constraint cᵢ specifies either (a) a respective minimum distance dᵢ between the object part qᵢ and the object part qᵢ₊₁ or (b) a respective target distance dᵢ between the object part qᵢ and the object part qᵢ₊₁ or (c) a respective maximum distance dᵢ between the object part qᵢ and the object part qᵢ₊₁; and

said at least one constraint c specifies either (a) a minimum distance d_{new} between the object part q₁ and the object part q_{w+1} or (b) a target distance d_{new} between the object part q₁ and the object part q_{w+1} or (c) a maximum distance d_{new} between the object part q₁ and the object part q_{w+1}, wherein the distance d_{new} is based on the distances d₁, . . . ,d_{w}.

### Example 12

The method of example 11, wherein d_{new}=αΣᵢ₌₁^{w}dᵢ, wherein a is a positive number.

### Example 13

The method of example 12, wherein α=1.

### Example 14

The method of example 12, wherein α>1

### Example 15

The method of any one of examples 10 to 14, wherein w=2.

### Example 16

The method of any one of examples 1 to 15, wherein applying a data set in the ordered sequence of data sets to the group of object parts comprises applying each constraint in said data set to the group of object parts.

### Example 17

The method of example 16, wherein applying a constraint to the group of object parts comprises updating at least one of the object parts of the two or more object parts in the group of object parts between which said constraint specifies a respective relationship.

### Example 18

The method of example 17, wherein applying a constraint to the group of object parts comprises updating at least one object part in the group of object parts other than the two or more object parts in the group of object parts between which said constraint specifies a respective relationship.

### Example 19

The method of any one of examples 16 to 18, wherein applying a data set in the ordered sequence of data sets to the group of object parts comprises applying each constraint in said data set to the group of object parts in an order for applying the constraints in said data set.

### Example 20

The method of example 19, wherein the order for applying the constraints in said data set is dependent on which iteration step is being performed.

### Example 21

The method of example 20, wherein, for an even numbered iteration step, the order for applying the constraints in said data set is a reverse of the order for applying the constraints in said data set for an odd numbered iteration step.

### Example 22

The method of any one of examples 16 to 21, wherein for at least one data set in the ordered sequence of data sets, each iteration step is arranged to apply said data set consecutively a respective predetermined number of times, said predetermined number being greater than 1.

### Example 23

An animation configuration system for configuring animation of a virtual object, wherein the animation configuration system comprises a memory and a processor, wherein the processor is configured to:

generate and store in the memory, for a group of object parts of the virtual object, an ordered sequence of at least two data sets, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein said processor is arranged to generate the ordered sequence of at least two data sets by, for each data set in the ordered sequence of data sets other than the first data set in the ordered sequence of data sets, generating each constraint in said data set based, at least in part, on one or more respective constraints of one or more data sets that precede said data set in the ordered sequence of data sets; and

configure an animation system to animate the virtual object, wherein animation of the virtual object comprises the animation system performing a series of update steps, wherein each update step comprises:
for each object part in the group of object parts, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.

### Example 24

The system of example 23, wherein, for at least one data set in the ordered sequence of data sets other than the first data set in the ordered sequence of data sets, said generating each constraint in said at least one data set in the ordered sequence of data sets comprises ensuring that if a constraint is generated specifying a relationship for a first object part and a second object part that are more than a predetermined distance apart in an ordering for the group of object parts, then a further constraint is generated if possible for a third object part and a fourth object part, wherein the third object part and the first object part are no more than the predetermined distance part in the ordering for the group of object parts.

### Example 25

The system of example 23 or 24, wherein, for at least one data set in the ordered sequence of data sets other than the first data set in the ordered sequence of data sets, the processor is configured to generate a first subset of constraints in said at least one data set in the ordered sequence of data sets based on a predetermined ordering of the object parts in the group of object parts and the processor is configured to generate a second subset of constraints in said at least one data set in the ordered sequence of data sets based on a second ordering of the object parts in the group of object parts, wherein the second ordering of the object parts in the group of object parts is based on the predetermined ordering of the object parts in the group of object parts.

### Example 26

The system of example 23 or 24, wherein the group of object parts have a predetermined ordering and wherein, for at least one data set in the ordered sequence of data sets other than the first data set in the ordered sequence of data sets, the processor is arranged to generate the constraints in said at least one data set in the ordered sequence of data sets based on a modified version of the predetermined ordering of the object parts in the group of object parts.

### Example 27

A system for animating a virtual object, wherein the system comprises a memory and a processor, wherein the processor is configured to:

perform a series of update steps for a group of object parts of the virtual object, wherein the group of object parts has an associated ordered sequence of at least two data sets stored in a memory of the animation system, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein, for each data set in the ordered sequence of data sets other than the first data set in the ordered sequence of data sets, each constraint in said data set is based, at least in part, on one or more respective constraints of one or more data sets that precede said data set in the ordered sequence of data sets, wherein each update step comprises:
for each object part in a group of object parts of the virtual object, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.

### Example 28

The system of any one of examples 23 to 27, wherein each iteration step comprises:

determining whether to terminate the iterative process;

if the iterative process is not to be terminated, applying the data sets in the ordered sequence of data sets, in the order for the ordered sequence of data sets, to the group of object parts terminating the iterative process.

### Example 29

The system of example 28, wherein determining whether to terminate the iterative process comprises determining to terminate the iterative process if a predetermined number of iteration steps have been performed for said update step.

### Example 30

The system of example 28 or 29, wherein determining whether to terminate the iterative process comprises determining to terminate the iterative process if the group of object parts satisfies a predetermined number of constraints from the data sets in the ordered sequence of data sets.

### Example 31

The system of example 28 or 29, wherein determining whether to terminate the iterative process comprises determining to terminate the iterative process if the group of object parts satisfies a predetermined proportion of constraints from the data sets in the ordered sequence of data sets.

### Example 32

The system of any one of examples 23 to 31, wherein at least one constraint c of at least one data set in the ordered sequence of data sets other than the first data set in the ordered sequence of data sets is based on a corresponding number w of respective constraints c₁, . . . , c_{w} of one or more data sets that precede said at least one data set in the ordered sequence of data sets, wherein w is an integer greater than 1, wherein for each i=1, . . . , w, the constraint cᵢ specifies a relationship between an object part qᵢ and an object part qᵢ₊₁, wherein said at least one constraint c is a constraint that specifies a relationship between the object part q₁ and the object part q_{w+1}.

### Example 33

The system of example 32, wherein:

for each i=1, . . . w, the constraint cᵢ specifies either (a) a respective minimum distance dᵢ between the object part qᵢ and the object part qᵢ₊₁ or (b) a respective target distance dᵢ between the object part qᵢ and the object part qᵢ₊₁ or (c) a respective maximum distance dᵢ between the object part qᵢ and the object part qᵢ₊₁; and

said at least one constraint c specifies either (a) a minimum distance d_{new} between the object part q₁ and the object part q_{w+1} or (b) a target distance d_{new} between the object part q₁ and the object part q_{w+1} or (c) a maximum distance d_{new} between the object part q₁ and the object part q_{w+1}, wherein the distance d_{new} is based on the distances d₁, . . . , d_{w}.

### Example 34

The system of example 33, wherein d_{new}=αΣᵢ₌₁^{w}dᵢ, wherein a is a positive number.

### Example 35

The system of example 34,wherein α=1.

### Example 36

The system of example 34, wherein α>1

### Example 37

The system of any one of examples 32 to 36, wherein w=2.

### Example 38

The system of any one of examples 23 to 37, wherein applying a data set in the ordered sequence of data sets to the group of object parts comprises applying each constraint in said data set to the group of object parts.

### Example 39

The system of example 38, wherein applying a constraint to the group of object parts comprises updating at least one of the object parts of the two or more object parts in the group of object parts between which said constraint specifies a respective relationship,

### Example 40

The system of example 39, wherein applying a constraint to the group of object parts comprises updating at least one object part in the group of object parts other than the two or more object parts in the group of object parts between which said constraint specifies a respective relationship.

### Example 41

The system of any one of examples 38 to 40, wherein applying a data set in the ordered sequence of data sets to the group of object parts comprises applying each constraint in said data set to the group of object parts in an order for applying the constraints in said data set.

### Example 42

The system of example 41, wherein the order for applying the constraints in said data set is dependent on which iteration step is being performed.

### Example 43

The system of example 42, wherein, for an even numbered iteration step, the order for applying the constraints in said data set is a reverse of the order for applying the constraints in said data set for an odd numbered iteration step.

### Example 44

The system of any one of examples 38 to 43, wherein for at least one data set in the ordered sequence of data sets, each iteration step is arranged to apply said data set consecutively a respective predetermined number of times, said predetermined number being greater than 1.

### Example 45

A computer program which, when executed by a processor, causes the processor to carry out a method according to any one of examples 1 to 22.

### Example 46

A computer readable medium storing a computer program according to example 45.

### 4—Modifications

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different information processing systems. In particular, although the figures and the discussion thereof provide an exemplary computing system and method, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention, It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules; multiple method steps implemented in flowcharts contained herein, or as described above, may be implemented together by a single module,

It will be appreciated that, insofar as embodiments of the invention are implemented by a computer program, then one or more storage media and/or one or more transmission media storing or carrying the computer program form aspects of the invention. The computer program may have one or more program instructions, or program code, which, when executed by one or more processors (or one or more computers), carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, byte code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1-4. (canceled)

5. A computer-implemented method of animating a virtual object, wherein the method comprises:
performing, with a processor of an animation system, a series of update steps for a group of object parts of the virtual object, wherein the group of object parts has an associated ordered sequence of at least two data sets stored in a memory of the animation system, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein, for each data set in the ordered sequence of data sets other than the first data set in the ordered sequence of data sets, each constraint in said data set is based, at least in part, on one or more respective constraints of one or more data sets that precede said data set in the ordered sequence of data sets, wherein each update step comprises:
for each object part in a group of object parts of the virtual object, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.

6. The method of claim 5, wherein each iteration step comprises:
determining whether to terminate the iterative process;
if the iterative process is not to be terminated, applying the data sets in the ordered sequence of data sets, in the order for the ordered sequence of data sets, to the group of object parts terminating the iterative process.

7. The method of claim 6, wherein determining whether to terminate the iterative process comprises determining to terminate the iterative process if a predetermined number of iteration steps have been performed for said update step.

8. The method of claim 6, wherein determining whether to terminate the iterative process comprises determining to terminate the iterative process if the group of object parts satisfies a predetermined number of constraints from the data sets in the ordered sequence of data sets.

9. The method of claim 6, wherein determining whether to terminate the iterative process comprises determining to terminate the iterative process if the group of object parts satisfies a predetermined proportion of constraints from the data sets in the ordered sequence of data sets.

10. The method of claim 5, wherein at least one constraint c of at least one data set in the ordered sequence of data sets other than the first data set in the ordered sequence of data sets is based on a corresponding number w of respective constraints c₁, . . . ,c_{w} of one or more data sets that precede said at least one data set in the ordered sequence of data sets, wherein w is an integer greater than 1, wherein for each i=1, . . . ,w, the constraint cᵢ specifies a relationship between an object part qᵢ and an object part qᵢ₊₁, wherein said at least one constraint c is a constraint that specifies a relationship between the object part qᵢ and the object part q_{w+1}.

11. The method of claim 10, wherein:
for each i=1, . . . w, the constraint cᵢ specifies either (a) a respective minimum distance di between the object part qᵢ and the object part qᵢ₊₁ or (b) a respective target distance dᵢ between the object part qᵢ and the object part qᵢ₊₁ or (c) a respective maximum distance dᵢ between the object part qᵢ and the object part qᵢ₊₁; and
said at least one constraint c specifies either (a) a minimum distance d_{new} between the object part qᵢ and the object part q_{w+1} or (b) a target distance d_{new} between the object part q₁ and the object part q_{w+1} or (c) a maximum distance d_{new} between the object part q₁ and the object part q_{w+1} wherein the distance dam is based on the distances

12.-15. (canceled)

16. The method of claim 5, wherein applying a data set in the ordered sequence of data sets to the group of object parts comprises applying each constraint in said data set to the group of object parts.

17. The method of claim 16, wherein applying a constraint to the group of object parts comprises updating at least one of the object parts of the two or more object parts in the group of object parts between which said constraint specifies a respective relationship.

18. The method of claim 17, wherein applying a constraint to the group of object parts comprises updating at least one object part in the group of object parts other than the two or more object parts in the group of object parts between which said constraint specifies a respective relationship.

19. The method of claim 16, wherein applying a data set in the ordered sequence of data sets to the group of object parts comprises applying each constraint in said data set to the group of object parts in an order for applying the constraints in said data set.

20. The method of claim 19, wherein the order for applying the constraints in said data set is dependent on which iteration step is being performed.

21. The method of claim 20, wherein, for an even numbered iteration step, the order for applying the constraints in said data set is a reverse of the order for applying the constraints in said data set for an odd numbered iteration step.

22. The method of claim 16, wherein for at least one data set in the ordered sequence of data sets, each iteration step is arranged to apply said data set consecutively a respective predetermined number of times, said predetermined number being greater than 1.

23.-26. (canceled)

27. A system for animating a virtual object, wherein the system comprises a memory and a processor, wherein the processor is configured to:
perform a series of update steps for a group of object parts of the virtual object, wherein the group of object parts has an associated ordered sequence of at least two data sets stored in a memory of the animation system, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein, for each data set in the ordered sequence of data sets other than the first data set in the ordered sequence of data sets, each constraint in said data set is based, at least in part, on one or more respective constraints of one or more data sets that precede said data set in the ordered sequence of data sets, wherein each update step comprises:
for each object part in a group of object parts of the virtual object, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.

28. The system of claim 27, wherein each iteration step comprises:
determining whether to terminate the iterative process;
if the iterative process is not to be terminated, applying the data sets in the ordered sequence of data sets, in the order for the ordered sequence of data sets, to the group of object parts terminating the iterative process.

29. The system of claim 28, wherein determining whether to terminate the iterative process comprises determining to terminate the iterative process if a predetermined number of iteration steps have been performed for said update step.

30. The system of claim 28, wherein determining whether to terminate the iterative process comprises determining to terminate the iterative process if the group of object parts satisfies a predetermined number of constraints from the data sets in the ordered sequence of data sets.

31. The system of claim 28, wherein determining whether to terminate the iterative process comprises determining to terminate the iterative process if the group of object parts satisfies a predetermined proportion of constraints from the data sets in the ordered sequence of data sets.

32.-46. (canceled)

47. A non-transient computer-readable storage medium storing instructions, which when executed by a processor, cause the processor to:
perform a series of update steps for a group of object parts of the virtual object, wherein the group of object parts has an associated ordered sequence of at least two data sets stored in a memory of the animation system, wherein each data set comprises one or more respective constraints, wherein each constraint specifies a respective relationship between two or more object parts in the group of object parts that are updateable by application of the constraint, wherein the first data set in the ordered sequence of data sets is a specified data set of one or more constraints and wherein, for each data set in the ordered sequence of data sets other than the first data set in the ordered sequence of data sets, each constraint in said data set is based, at least in part, on one or more respective constraints of one or more data sets that precede said data set in the ordered sequence of data sets, wherein each update step comprises:
for each object part in a group of object parts of the virtual object, updating that object part; and
performing an iterative process that comprises one or more iteration steps, wherein each iteration step is arranged to apply, as necessary, the data sets in the ordered sequence of data sets, in the order for the ordered sequence of data sets, to the group of object parts.
